(19) United States
(12) Patent Application Publication
(10) Pub. No.: US 2024/0385298 A1
(43) Pub. Date: Nov. 21, 2024

(54) NOISE REMOVAL APPARATUS, OBJECT DETECTION APPARATUS, AND NOISE REMOVAL METHOD

(71) Applicant: DENSO CORPORATION, Kariya-city (JP)

(72) Inventor: Keiko AKIYAMA, Kariya-city (JP)

(21) Appl. No.: 18/787,242

(22) Filed: Jul. 29, 2024

Related U.S. Application Data
(63) Continuation of application No. PCT/JP2023/008857, filed on Mar. 8, 2023.

(30) Foreign Application Priority Data
Mar. 24, 2022 (JP) 2022-048098
Feb. 27, 2023 (JP) 2023-028105

(51) Int. Cl. G01S 7/487; G01S 7/48; G01S 7/497; G01S 17/42; G01S 17/931

(52) U.S. Cl. CPC G01S 7/4876; G01S 7/4802; G01S 7/497; G01S 17/42; G01S 17/931

(57) ABSTRACT

A noise removal apparatus removes noise generated when a detection target is recognized using reflection of light. The noise removal apparatus includes a measurement unit, a determination unit, and a removal unit. The measurement unit measures an intensity of arrival light, which arrives in a direction corresponding to an emission direction of light emitted toward a predetermined range, in an elapsed time from emission of the light. The determination unit determines, when an echo having an intensity equal to or larger than a predetermined intensity arises in the measured arrival light, whether the echo is reflected by the detection target located in the predetermined range, using the intensity of the echo and a detection distance corresponding to the elapsed time. The removal unit removes, as noise, the echo determined not to be reflected by the detection target.

### CROSS REFERENCE TO RELATED APPLICATION

The present application is a continuation application of International Patent Application No. PCT/JP2023/008857 filed on Mar. 8, 2023, which designated the U.S. and claims the benefit of priority from Japanese Patent Applications No. 2022-48098 filed on Mar. 24, 2022 and No. 2023-28105 filed on Feb. 27, 2023. The entire disclosures of all of the above applications are incorporated herein by reference.

### TECHNICAL FIELD

The present disclosure relates to a noise removal apparatus, an object detection apparatus, and a noise removal method.

### BACKGROUND

There is known a technique of recognizing a detection target and measuring a distance to the detection target.

### SUMMARY

According to an aspect of the present disclosure, a noise removal apparatus is configured to remove noise generated when a detection target is recognized using reflection of light.

### BRIEF DESCRIPTION OF THE DRAWINGS

The above and other objects, features and advantages of the present disclosure will become more apparent from the following detailed description made with reference to the accompanying drawings. In the drawings:

FIG. 1 is an explanatory diagram showing a state in which a vehicle performs target object recognition;

FIG. 2 is a schematic configuration diagram showing a configuration of a target object recognition apparatus in which a noise removal apparatus according to a first embodiment is incorporated;

FIG. 3A is an explanatory diagram showing a schematic configuration of a light receiving and emitting unit;

FIG. 3B is an explanatory diagram showing a relationship between a light emission signal and a light reception signal;

FIG. 4 is a flowchart showing an example of a target object recognition processing routine;

FIG. 5 is a flowchart showing an example of two-stage threshold determination processing;

FIG. 6A is an explanatory diagram showing an intensity ratio handled as an intensity of the light reception signal;

FIG. 6B is an explanatory diagram showing an overview of processing on an echo in the light reception signal;

FIG. 7 is a flowchart showing an example of noise removal processing;

FIG. 8 is an explanatory diagram showing presence of reflected light from a raindrop or a black-painted vehicle in relation to a distance to a detection target and a signal intensity;

FIG. 9 is an explanatory diagram showing an example of a threshold for separating noise from an actual signal;

FIG. 10 is a flowchart showing an example of isolated point removal processing;

FIG. 11 is an explanatory diagram showing a state of reflected light from a road surface;

FIG. 12 is a flowchart showing an example of processing of counting the number of proximity points;

FIG. 13 is a schematic configuration diagram showing an internal configuration of an object surface recognition apparatus in which a noise removal apparatus according to a second embodiment is incorporated;

FIG. 14A is a flowchart showing a correction coefficient acquisition processing routine;

FIG. 14B is a graph schematically showing a one-dimensional table for obtaining a correction coefficient;

FIG. 15 is a flowchart showing a two-stage threshold determination processing routine in the second embodiment;

FIG. 16 is a flowchart showing a first noise removal processing in the second embodiment;

FIG. 17 is an explanatory diagram showing a state of noise removal;

FIG. 18 is a schematic configuration diagram of a vehicle equipped with a target object recognition apparatus in which a noise removal apparatus according to a third embodiment is incorporated;

FIG. 19 is a flowchart showing a noise level calibration processing routine in the third embodiment;

FIG. 20 is an explanatory diagram showing an example of calibration processing;

FIG. 21 is a flowchart showing noise determination processing in a fourth embodiment; and

FIG. 22 is an explanatory diagram showing a state in which noise removal is performed by switching a detection target region.

### DESCRIPTION OF EMBODIMENTS

Hereinafter, examples of the present disclosure will be described.

An object detection apparatus according to an example of the present disclosure emits light such as infrared light to a predetermined range and detects reflected light from a detection target located in the range, and thus recognizes the detection target or measures a distance to the detection target.

In such optical measurement, removal of noise caused by an influence of ambient light or the like is studied. According to an example of the present disclosure, a noise component is removed by receiving a reflected wave multiple times and superimposing the reflected waves. According to another example of the present disclosure, an isolated point having a distance largely different from that of a neighboring pixel is removed as noise.

However, various problems remain in such a noise removal technique. In one case, when recognition of a detection target or distance measurement is optically performed outdoors, there is an influence of rain or ambient light, an intensity of a reflected wave from a raindrop or the like may be high, and for example, removal may not be performed even when measurement results of multiple times are superimposed. Such a problem is significant due to a raindrop at a position close to a measurement point or clutter or the like caused by ambient light. In addition, at an object that hardly reflects emission light, for example, a vehicle body painted in black, an intensity of reflected light may be low, and it is difficult to recognize a detection target or measure a distance simply by increasing a threshold for removing a noise component.

According to an example of the present disclosure, a noise removal apparatus is configured to remove noise generated when a detection target is recognized using reflection of light. The noise removal apparatus comprises:
a measurement unit configured to measure an intensity of arrival light, which arrives in a direction corresponding to an emission direction of light emitted toward a predetermined range, in an elapsed time from emission of the light;
a determination unit configured to determine, when an echo having an intensity equal to or larger than a predetermined intensity arises in the measured arrival light, whether the echo is reflected by the detection target located in the predetermined range, using the intensity of the echo and a detection distance corresponding to the elapsed time; and
a removal unit configured to remove, as noise, the echo determined not to be reflected by the detection target.

According to another example of the present disclosure, a noise removal method is for removing noise generated when a detection target is recognized using reflection of light. The noise removal method comprises:
measuring an intensity of arrival light, which arrives in a direction corresponding to an emission direction of light emitted toward a predetermined range, in an elapsed time from emission of the light;
setting a determination condition when determining whether an echo having an intensity equal to or larger than a predetermined intensity arises in the measured arrival light, based on at least one of an environment where the recognition is performed and a characteristic when performing the measurement;
determining, when determination that the echo having the intensity equal to or larger than the predetermined intensity arises in the measured arrival light is made under the set determination condition, whether the echo is reflected by the detection target located in the predetermined range, using the intensity of the echo and the detection distance corresponding to the elapsed time; and
removing, as noise, the echo determined not to be reflected by the detection target.

### A. First Embodiment

### (A1) Hardware Configuration:

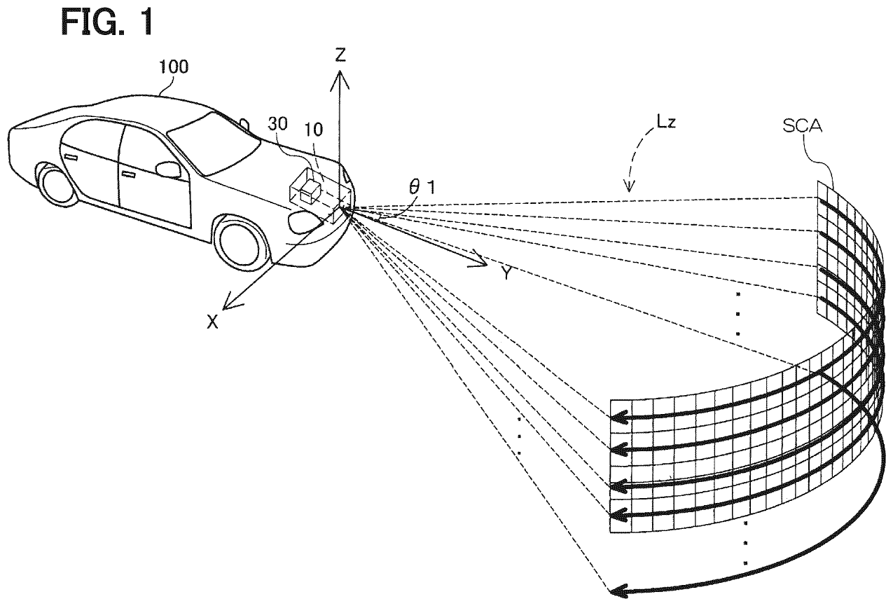

FIG. 1 shows an overview of an operation of a target object recognition apparatus 10 including a noise removal apparatus 30 according to a first embodiment. As shown in the drawing, the target object recognition apparatus 10 is mounted on a vehicle 100, measures a distance to a target object located in the vicinity of the front of the vehicle 100, for example, another vehicle, a pedestrian, or a building, and recognizes the target object. In the present embodiment, the target object recognition apparatus 10 includes light detection and ranging (LiDAR). The target object recognition apparatus 10 emits emission light Lz, which is pulsed light, to a predetermined range SCA while performing scanning, and receives reflected light corresponding to the emission light Lz. For example, if there is a detection target in the predetermined range SCA, the emission light Lz hits an object, and reflected light of the object is returned. An intensity of the reflected light differs not only between presence and absence of the object but also between portions having different reflectances on a surface of the object, for example, between a black portion and a white portion. As an example, a lane line on a road surface may be recognized based on reflected light from the lane line. Therefore, targets of detection and recognition in this manner may be collectively referred to as “target object”.

The target object recognition apparatus 10 in the present embodiment receives the reflected light, removes noise in a light reception signal obtained corresponding to the reflected light by the noise removal apparatus 30, and then recognizes a distance to the detection target and what the target object is. Hereinafter, the noise removal apparatus 30 will be described together with a configuration and a function as the target object recognition apparatus 10, and the noise removal apparatus 30 may operate independently or be implemented as an apparatus other than the target object recognition apparatus 10.

In FIG. 1, an emission center position of the emission light Lz is an origin, a front-rear direction of the vehicle 100 is a Y-axis, a width direction of the vehicle 100 passing through the origin is an X-axis, and a vertical direction passing through the origin is a Z-axis. A forward direction of the vehicle 100 is defined as a +Y direction, a rearward direction of the vehicle 100 is defined as a −Y direction, a rightward direction of the vehicle 100 is defined as a +X direction, a leftward direction of the vehicle 100 is defined as a −X direction, a vertically upward direction is defined as a +Z direction, and a vertically downward direction is defined as a −Z direction. The emission light Lz is a collection of light from multiple light emitting devices arranged in the Z-axis direction for a purpose to be described later, and a light projection region thereof has a vertically long shape along the Z direction. The vertically long emission light Lz is emitted to a predetermined range by one-dimensionally scanning in the X-axis direction. As shown by a thick solid arrow in FIG. 1, the multiple light emitting devices emit light at a predetermined time interval while scanning the emission light Lz from left to right in the forward direction of the vehicle 100. The emission light Lz is pulsed light and thus can be regarded as being emitted to each grid cell indicated by thin solid lines in the drawing. A scanning speed and a pulse interval of the emission light Lz, which is pulsed light, determine a resolution 61 of the target object recognition apparatus 10 in the X-axis direction. A resolution of the target object recognition apparatus 10 in the Z-axis direction is determined by an interval between the multiple light emitting devices in the Z direction.

The target object recognition apparatus 10 detects the target object as a distance measurement point cloud by measuring a time from emission of the emission light Lz to reception of the reflected light, that is, a time of flight TOF of the light, and calculating a distance to the target object based on the time of flight TOF. A distance measurement point means a point indicating a position where at least a part of the target object specified by the reflected light can be located in a range measurable by the target object recognition apparatus 10. The distance measurement point cloud means a collection of distance measurement points in a predetermined period. The target object recognition apparatus 10 recognizes the target object, using a shape specified by three-dimensional coordinates of the detected distance measurement point cloud and reflection characteristics of the distance measurement point cloud.

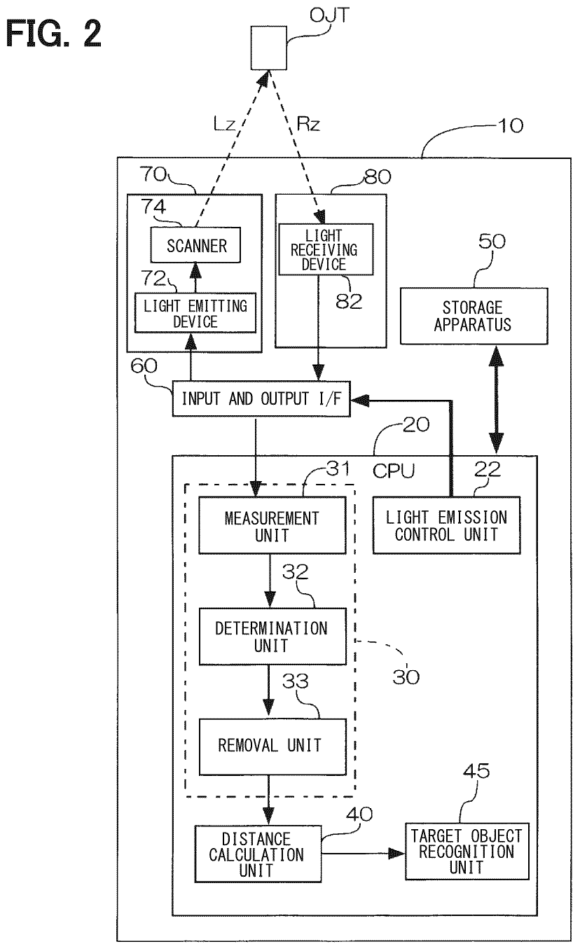

As shown in FIG. 2, the target object recognition apparatus 10 includes a CPU 20, a storage apparatus 50, an input and output interface 60, a light emitting unit 70, and a light receiving unit 80. The CPU 20, the storage apparatus 50, and the input and output interface 60 are connected to the CPU 20. The storage apparatus 50 includes a magnetic storage apparatus such as a hard disk in addition to a semiconductor storage apparatus such as a ROM, a RAM, and an EEPROM. The light emitting unit 70 and the light receiving unit 80 are connected to the input and output interface 60.

By reading and executing a computer program stored in the storage apparatus 50, the CPU 20 functions as the noise removal apparatus 30, and also functions as a light emission control unit 22, a distance calculation unit 40, and a target object recognition unit 45. The light emission control unit 22, the distance calculation unit 40, and the target object recognition unit 45 may be implemented as separate apparatuses operating according to an instruction from the CPU 20.

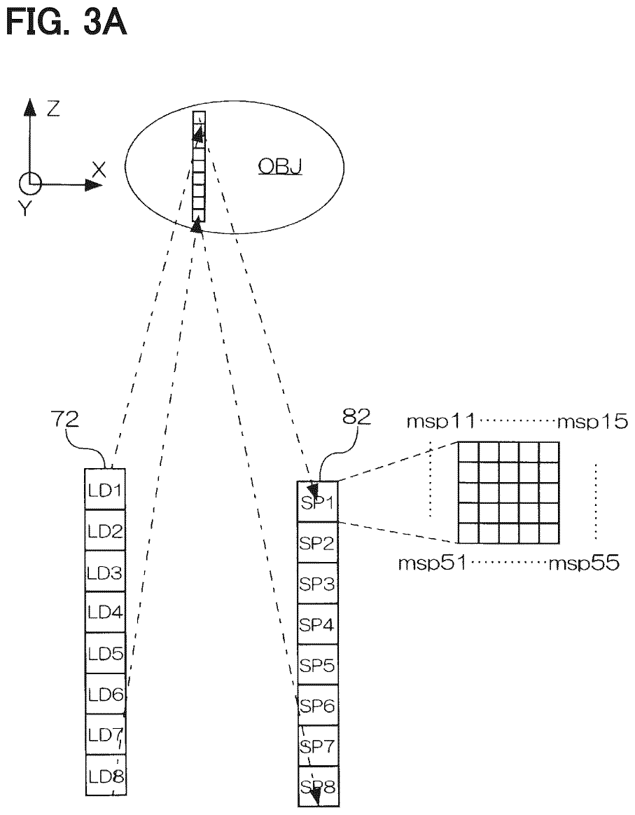

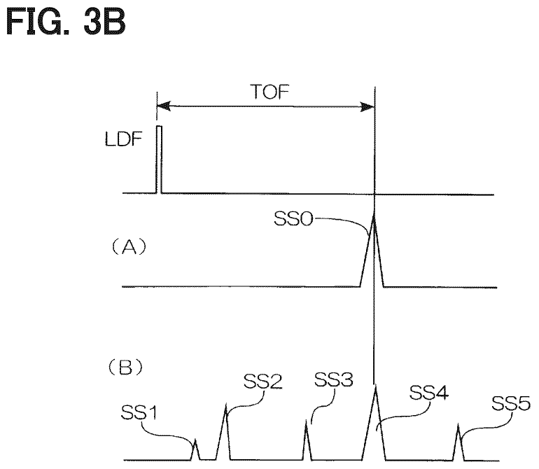

The light emission control unit 22 transmits a light emission signal to the light emitting unit 70 at a regular interval via the input and output interface 60. The light emitting unit 70 includes a light emitting device 72 and a scanner 74. As shown in FIG. 3A, the light emitting device 72 includes multiple laser diodes LD1 to LD8 arranged in the Z direction. When a pulsed light emission signal is received, the laser diodes LD1 to LD8 emit light according to a pulse and emit the emission light Lz. The laser diodes LD1 to LD8 emit, for example, infrared light as the emission light Lz. The scanner 74 includes, for example, a mirror or a digital mirror device (DMD), and scans the emission light emitted from the laser diodes LD1 to LD8 from the −X direction to the +X direction at a regular interval. The number of laser diodes may be one or multiple. In the case of one or a small number, the scanner 74 may be configured to enable scanning in the Z-axis direction in addition to the X-axis direction, that is, in a two-dimensional direction. The light emitting devices 72 may be two-dimensionally arranged in the X direction and the Z direction, and the scanning by the scanner 74 may be omitted.

The light receiving unit 80 includes multiple light receiving devices 82. As indicated by reference numerals SP1 to SP8, eight light receiving devices 82 are arranged in the Z direction. One light receiving device 82 includes 5×5 micro SPADs (msp11 to msp55) arranged two-dimensionally, and 25 micro SPADs constitute one light receiving device 82. Each micro SPAD is a single photon avalanche diode, which outputs a binary signal indicating whether a photon is incident thereon, and the light receiving device 82 including the 25 micro SPADs can output a signal corresponding to how many of the micro SPADs detect the reflected light, that is, an intensity signal indicating an intensity of arrival light that arrives at the light receiving device 82. The arrangement of the micro SPADs may have another configuration such as 3×6.

As shown in FIG. 3B, when a light emission signal LDF is output from the light emission control unit 22 of the CPU 20 and one of the laser diodes LD1 to LD8 constituting the light emitting device 72 emits light, reflected light of emission light thereof reflected by a detection target OJT is incident on the light receiving device 82. Then, the light receiving device 82 outputs a signal corresponding to an intensity of the reflected light along an elapsed time from the light emission of the light emitting device 72. Most of the arrival light arriving at the light receiving device 82 is the reflected light of the light emitted from the light emitting device 72, which is reflected by the object, whereas external light and stray light reflected multiple times are also incident thereon. Since the light receiving device 82 cannot detect only the reflected light in the arrival light, the noise removal apparatus 30 or the like implemented by the CPU 20 removes an influence of the external light and the like and calculates a distance to the detection target OJT, a reflected light intensity, or the like based on the reflected light from the detection target OJT.

If the detection target OJT is a wall located at a place separated by a predetermined distance from the target object recognition apparatus 10 and there is nothing between the target object recognition apparatus 10 and the detection target OJT, a light reception signal becomes a signal having a peak SS3 at a position separated from the light emission signal LDF by the time TOF corresponding to the distance to the detection target OJT, as shown in (A) in FIG. 3B. However, actually, noise caused by various factors is superimposed on the light reception signal, and for example, as shown in (B) in FIG. 3B, other peaks SS1 and SS2 may appear in the light reception signal. The noise removal apparatus 30 that receives the light reception signal via the input and output interface 60 removes such noise from the light reception signal. The noise removal apparatus 30 includes a measurement unit 31 that receives a signal from the light receiving unit 80 and measures a signal intensity, an elapsed time, or the like, a determination unit 32 that determines whether an echo in the measured light reception signal is an echo due to the reflected light from the detection target, a removal unit 33 that removes noise, and the like. Details of noise removal processing performed by the removal unit 33 will be described later.

The light reception signal output from the noise removal apparatus 30, that is, the light reception signal from which the noise is removed is output to the distance calculation unit 40. The distance calculation unit 40 calculates the distance from the target object recognition apparatus 10 to the detection target OJT based on the time (TOF) from light emission to reception of the light reception signal. Specifically, the distance calculation unit 40 calculates a distance D from the target object recognition apparatus 10 to a reflection point of the detection target OJT, using the time TOF from when the laser diodes LD1 to LD8 emit the emission light Lz to when the emission light Lz hits the detection target OJT and reflected light Rz thereof is received by the light receiving device 82 of the light receiving unit 80. The distance D from the target object recognition apparatus 10 to the reflection point of the detection target OJT can be obtained as D=TOF/(2·c),
where c is the speed of light. The target object recognition unit 45 receives a calculation result of the distance calculation unit 40, identifies a position of the reflection point of the detection target OJT based on a direction of the reflection point of the detection target OJT and the distance D to the reflection point, and recognizes the target object based on collection thereof.

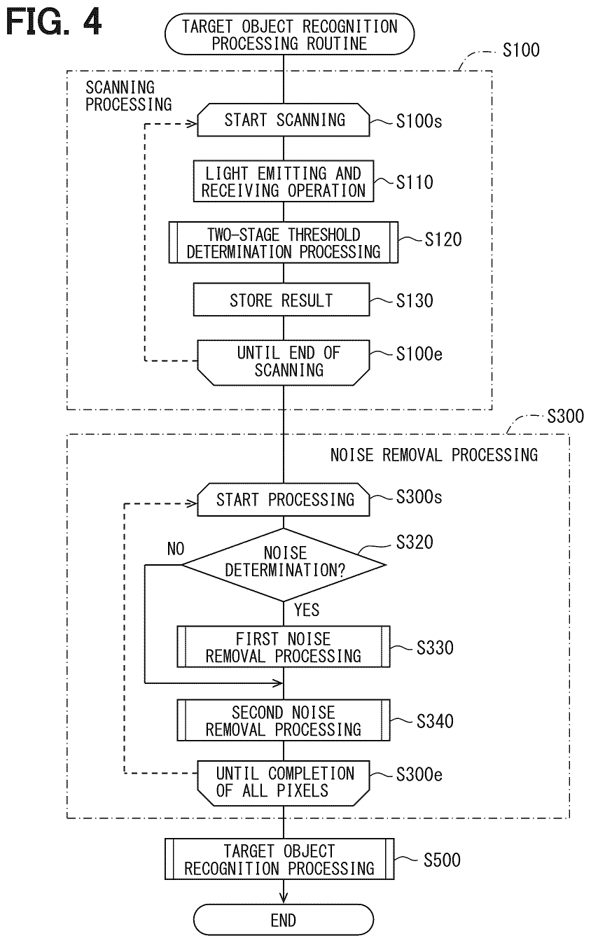

An overview of target object recognition processing performed by the CPU 20 will be described with reference to a flowchart in FIG. 4. A shown target object recognition processing routine is repeatedly performed at a predetermined interval when an ignition switch (not shown) of the vehicle 100 is turned on and power supply to the target object recognition apparatus 10 is started. The shown routine is roughly divided into three steps, that is, scanning processing (step S100) of scanning the predetermined range SCA with laser light and collecting data of a light reception signal of reflected light at all pixels belonging to the predetermined range SCA, the noise removal processing (step S300) of performing processing to remove noise for the collected data of the light reception signal, and recognition processing (step S500) of calculating a distance to the target object located in the predetermined range SCA after noise removal and recognizing the target object.

When the scanning processing (step S100) is started, the scanner 74 is first activated to start scanning with the laser light (step S100s). Processing (steps S110 to S130) after the scanning is repeated until the scanning ends (step S100e). A period from the start to the end of the scanning corresponds to scanning the predetermined range SCA shown in FIG. 1 from the origin to an end point of a diagonal thereof.

When the scanning is started, first, light emitting and receiving operations are performed (step S110). As described above, such processing is processing of outputting the light emission signal LDF to one light emitting device 72 at the predetermined time interval and receiving the light reception signal from one light receiving device 82 of the light receiving unit 80. The light reception signal is a signal corresponding to one of multiple pixels forming the predetermined range SCA. In a light reception signal TS, a peaked signal waveform having a peak and a predetermined time span appears due to various factors. The peaked signal waveform including the peak is referred to as an echo in the following description regardless of a magnitude of a peak value. The echo is generated by the reflected light from the detection target OJT in one case, and may also be generated by a so-called clutter. Two-stage threshold determination processing (step S120) is performed on the light reception signal, and an echo TSn in the light reception signal is extracted based on an intensity of the light reception signal.

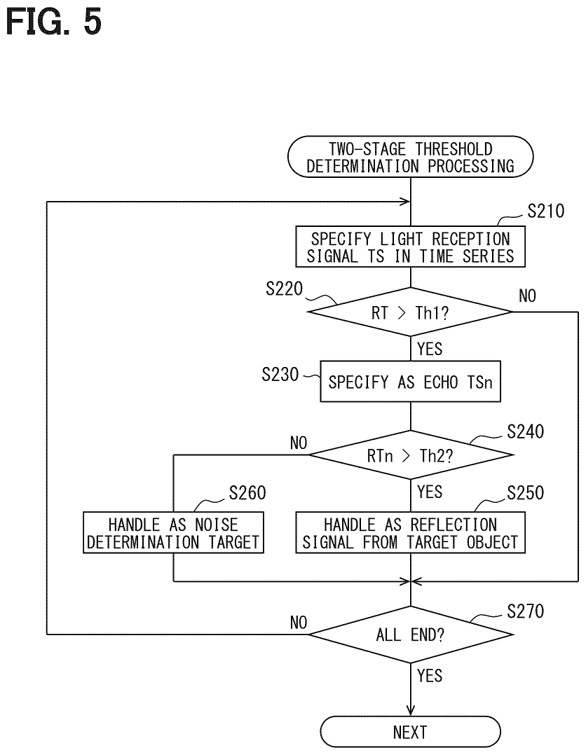

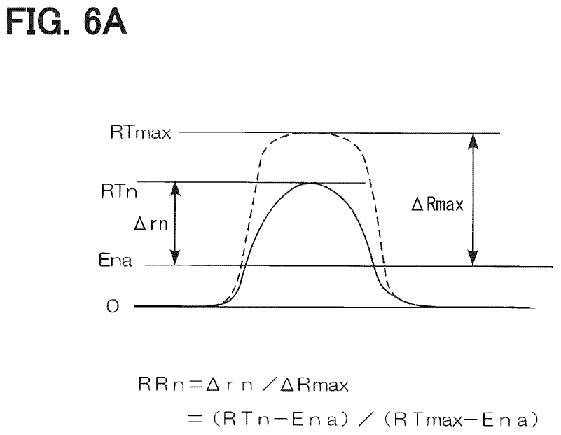

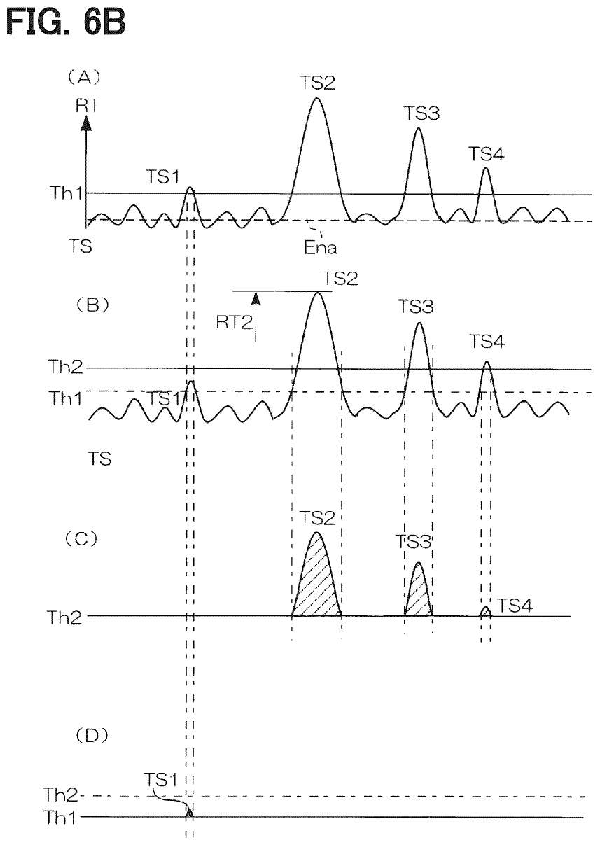

An overview of such two-stage threshold determination processing is shown in FIG. 5. The light reception signal TS handled in the two-stage threshold determination processing (step S120) is a signal read in step S110. A signal from the light receiving device 82 may be directly used as the light reception signal TS as a target to be processed, or may be temporarily stored in the storage apparatus 50 and sequentially read as the target to be subjected to signal processing. In the two-stage threshold determination processing, first, a signal intensity RT of the light reception signal TS is read in time series with a time point when the light emission signal LDF is output being a time 0 (step S210), and it is determined whether there is a portion where the signal intensity RT of the light reception signal TS is larger than a first threshold Th1 (step S220). The signal intensity RT of the light reception signal TS is the intensity of the signal obtained from the light receiving device 82 at one point on a time axis, and in the present embodiment, the signal corresponds to the number of micro SPADs among the 25 micro SPADs which detect a photon and activate output thereof. As shown in FIG. 6A, the intensity of the light reception signal TS may be obtained as an intensity ratio RRn of an actual intensity difference Δrmax, which is a difference between a peak intensity RTn of the echo and an external light intensity Ena, to a maximum intensity difference ΔRmax, which is a difference between a maximum intensity RTmax obtainable by the light reception signal and the external light intensity Ena, that is,

$$RRn = Δ rn / Δ R max = ( R T n - E na ) / ( RT max - Ena ) ,$$

which may be handled as the intensity of the light reception signal.

When a period in which the signal intensity RT of the light reception signal TS read in time series satisfies RT>Th1

is found, the period is extracted as the echo TSn (step S230). Here, n has an initial value of 1, and is an integer value incremented each time when the period in which the signal intensity RT of the light reception signal TS is larger than the first threshold Th1 is found. This state is shown in (A) in FIG. 6B. In this example, the period in which the signal intensity RT of the light reception signal TS is larger than the first threshold Th1 is extracted as an echo TS1. Here, the first threshold Th1 is set to a value larger than the external light intensity Ena corresponding to an intensity of background light detected by the light receiving device 82. It is determined whether the peak intensity RTn of the extracted echo TSn, where the signal intensity RT of the light reception signal TS is larger than the first threshold Th1, is larger than a second threshold Th2 predetermined as a value larger than the first threshold Th1 (step S240).

As a result of the determination in step S240, if the echo TSn satisfies RTn>Th2, it is determined that the echo TSn is due to the reflected light from the target object, and the echo TSn is handled as a signal due to the reflected light from the target object (step S250). On the other hand, if the peak intensity RTn of the echo TSn does not satisfy RTn>Th2, it is determined that the echo TSn cannot be said to be due to the reflected light from the target object and may be noise, and the echo TSn is handled as a noise determination target (step S260). Thereafter, it is determined whether the light reception signal TS is read to the end in time series (step S270), and if the light reception signal TS is read to the end, the processing exits to “NEXT” and the present processing routine is ended, and if the light reception signal TS is not read to the end, the processing returns to step S210 and the above-described processing of reading the light reception signal TS in time series is repeated.

Usually, if the target object is located in a direction in which the laser light is emitted from the target object recognition apparatus 10, there is no reflected light from the target object at a place farther than the target object, and thus there is often one echo due to the reflected light from the target object. However, for example, when it rains, multiple echoes TSn may be contained in the light reception signal detected by the scanner 74 of the target object recognition apparatus 10, such as an echo due to reflected light of a raindrop and an echo due to reflected light caused by reflection of laser light passing through a raindrop by the target object. As a result, when the light reception signal TS is read to the end in time series, as shown in (A) in FIG. 6B, in some cases, multiple echoes TSn (four in the example in the drawing, that is, TS1 to TS4) are extracted as periods in which the peak intensity RTn exceeds the first threshold Th1. Further, the echoes TS2, TS3, and TS4 among these are determined as not being the noise determination target since peak intensities RT2, RT3, and RT4 thereof exceed the second threshold Th2 as shown in (B) and (C) in FIG. 6B, and meanwhile, the echo TS1 is a target of first noise determination processing to be described later, as shown in (D) in FIG. 6B, since a peak intensity RT1 thereof is between the first threshold Th1 and the second threshold Th2.

After the two-stage threshold determination processing described above, the signal intensity RTn of the echo in the light reception signal at the scanned position and a detection distance of the echo, that is, a detection distance LTn corresponding to a time from the output of the light emission signal LDF to the detection of the peak of the echo TSn are temporarily stored in the storage apparatus 50 in association with each other (step S130). The above-described processing (steps S110 to S130) is repeated until the scanning is finished for the entire predetermined range SCA (step S100e). When the scanning processing is completed for the entire predetermined range SCA, the noise removal processing (step S300) is performed next.

### (A2) Overview of Noise Removal Processing:

The noise removal processing (step S300) will be described. In the present embodiment, the CPU 20 that performs the noise removal processing (step S300) corresponds to the noise removal apparatus 30, and hardware corresponding to the noise removal apparatus 30 may be prepared separately from the CPU 20. Although electrical noise is also superimposed on the light reception signal obtained from the light receiving device 82, the noise to be removed by the noise removal apparatus 30 according to the present embodiment is not the electrical noise but is the clutter. The term “clutter” herein refers to a part that is unwanted in target object recognition among a signal waveform generated in the light receiving device 82 due to the light from the predetermined range SCA. The light receiving device 82 receives not only the reflected light from the detection target OJT of the laser light emitted by the light emitting device 72 according to the light emission signal LDF, but also various types of light including background light and the like. For example, if it rains, a part of the laser light may be reflected by a raindrop and be incident on the light receiving device 82. In addition, light reflected multiple times (stray light) may be incident on the object located in the predetermined range SCA. Since the micro SPAD of the light receiving device 82 has sensitivity capable of detecting even one photon, the light reception signal may have only one peak for the detection target OJT as shown in FIG. 3B ((A) in FIG. 3B), or may have a waveform having multiple peaks along the time axis ((B) in FIG. 3B).

With reference to FIG. 3B, there is only one echo (reference numeral SS0) in the light reception signal in (A) in FIG. 3B, whereas five echoes, that is, reference numerals SS1 to SS5, in the light reception signal are shown in (B) in FIG. 3B. In the latter case, it is necessary to perform processing to specify an echo to be excluded as noise and specify an echo corresponding to the detection target. Such processing is the noise removal processing.

The noise removal processing (step S300) includes first noise removal processing (step S330) of removing a clutter noise caused by a neighboring raindrop or the like and second noise removal processing (step S340) of removing an isolated point noise. The first noise removal processing (step S330) and the second noise removal processing (step S340) are continuously performed in the present embodiment, and may also be individually performed. The two pieces of processing are common in that it is determined, based on the intensity of the light reception signal and the detection distance, whether the echo in the light reception signal is due to the reflected light from the detection target. When the noise removal processing (step S300) is started, the following processing (steps S320 to S340) is repeated (steps S300s to S300e) for all pixels within the predetermined range SCA stored in the storage apparatus 50 by the scanning processing (step S100). First, it is determined whether to perform noise determination (step S320). If the echo TSn determined to be subjected to the noise determination by the two-stage threshold determination processing (step S120) is contained in a target pixel, the first noise removal processing (step S330) targeting on the echo TSn is performed, and then the second noise removal processing is performed. As in the echoes TS2 to TS4 shown in FIG. 6B, when it is determined that the echo is due to the reflected light from the detection target, the first noise removal processing (step S330) is not performed, and the second noise removal processing (step S340) is performed. On the other hand, when it is determined that there is an echo to be subjected to the noise determination, the first noise removal processing (step S330) and the second noise removal processing (step S340) are performed. The first noise removal processing (step S330) and the second noise removal processing (step S340) may be performed for all echoes without performing the determination in step S320.

### (A3) First Noise Removal Processing:

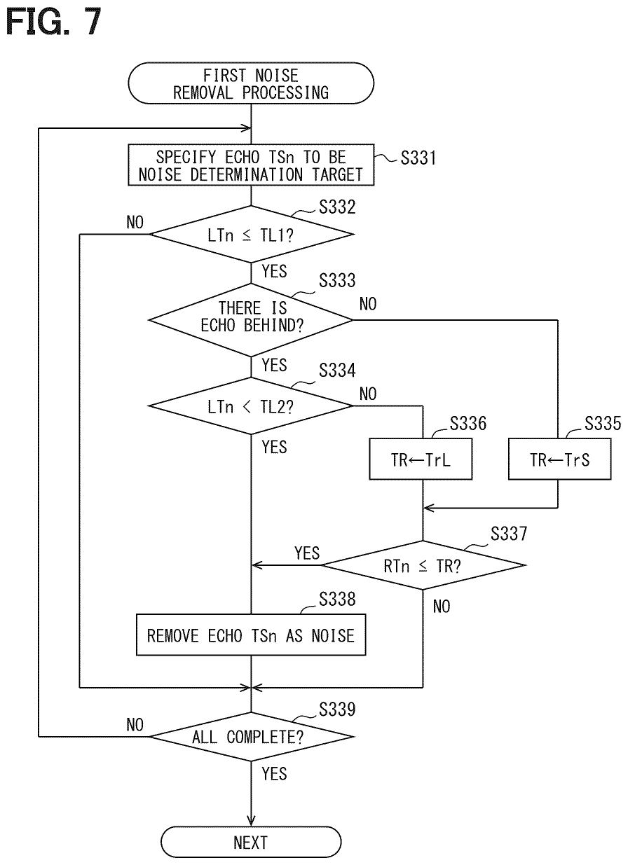

The first noise removal processing (step S330) will be described with reference to FIG. 7. The first noise removal processing is processing of removing the clutter noise due to the reflected light or the like caused by the neighboring raindrop. When such processing is started, first, the echo TSn (an initial value of n is 1) that is a noise determination target is specified (step S331). Next, it is determined whether the detection distance LTn corresponding to a time from the output of the light emission signal LDF to the detection of the peak of the echo TSn is equal to or less than a predetermined first distance threshold TL1 (step S332). Assuming that the echo TSn is a signal due to the reflected light from the detection target, the detection distance LTn, which is the distance to the detection target, is obtained by

$$LTn = c \cdot tn / 2 ,$$

where tn is the time from the light emission signal LDF to the peak of the echo and the speed of light is c/second. However, as signal processing, handling may be performed based on a time equivalent to the detection distance (hereinafter, referred to as a detection time tn).

When it is determined in step S332 that the detection distance LTn of the echo TSn is not equal to or less than the first distance threshold TL1 (for example, about 10 m), since the echo TSn is far, it is not determined that the echo is noise, and the following processing is not performed. On the other hand, if the detection distance LTn of the echo TSn is equal to or less than the first distance threshold TL1 (step S332: “YES”), then it is determined whether there is any echo behind the focused echo TSn (step S333). The expression “there is an echo behind” refers to, for example, as shown in FIG. 6B, a case where the second echo TS2 is behind the first echo TS1 that is the noise determination target on the time axis, that is, far from the target object recognition apparatus 10. In FIG. 6B, only the first echo TS1 is the noise determination target, and if the second echo TS2 is larger than the first threshold Th1 and smaller than the second threshold Th2, the second echo TS2 becomes the noise determination target, and a third echo TS3 or the like therebehind is handled as the echo behind.

If there is an echo that is not the noise determination target behind the echo TSn that is the noise determination target (step S333: “YES”), it is further determined whether the detection distance LTn of the echo TSn that is the determination target is smaller than the second distance threshold TL2 larger than the first distance threshold TL1 (step S334). As a result of such a series of determination (steps S332 to S334), when the detection distance LTn of the echo TSn that is the target of the noise determination processing is smaller than the first distance threshold TL1 (step S332: “YES”), there is another echo further behind the echo TSn (step S333: “YES”), and the detection distance LTn of the echo TSn is smaller than the second distance threshold TL2 (step S334: “YES”), the echo TSn is removed as noise (step S338).

On the other hand, even when the determination in one of steps S333 and S334 is not “YES”, in the following case, the echo TSn is regarded as noise and similarly removed in step S338. The determination processing is performed as follows. That is, when the detection distance LTn of the echo TSn that is the target of the noise determination processing is smaller than the first distance threshold TL1 (step S332: “YES”) and there is no echo further behind the echo TSn (step S333: “NO”), a noise determination threshold TR is set to a small threshold TrS (step S350), and on the other hand, when there is an echo further behind the echo TSn (step S333: “YES”) and the detection distance LTn of the echo TSn is not smaller than the second distance threshold TL2 (step S334: “NO”), the noise determination threshold TR is set to a large threshold TrL larger than the small threshold TrS (step S360). Then, it is determined whether the peak intensity RTn of the echo TSn handled in the noise determination is equal to or less than the noise determination threshold TR (step S337), and if the peak intensity RTn of the focused echo TSn is equal to or less than the noise determination threshold TR (“YES” in step S337), the echo TSn is removed as noise (step S338). A method of determining the large threshold TrL and the small threshold TrS used for such determination will be described in detail later.

In a case other than that described above, that is, in a case where the detection distance LTn of the echo TSn is not within the first distance threshold TL1 (step S332: “NO”), or in a case where the peak intensity RTn of the focused echo TSn is not equal to or less than the noise determination threshold TR (step S337: “NO”), the echo TSn cannot be determined as noise, and the processing proceeds to step S339. In step S339, if the determination for all extracted echoes TSn is not completed, the processing returns to step S331 and the above-described processing (steps S331 to S338) is repeated, and if the determination for all extracted echoes TSn is completed, the present noise removal processing is ended.

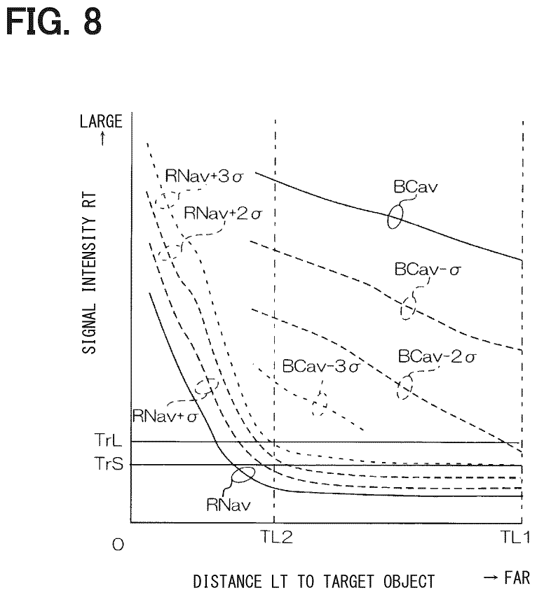

In the processing described above, it is determined that the echo TSn or the like generated by the reflected light from the raindrop is a clutter noise, and it is determined that the echo TSn generated by the reflected light from the detection target to be detected, such as a black vehicle, is not noise. Such processing utilizes the fact that the reflected light from the raindrop or the like and the reflected light from the detection target have the following characteristics. The first distance threshold TL1, the second distance threshold TL2, the small threshold TrS, and the large threshold TrL used in the above-described processing are set based on the characteristics of the reflected light. FIG. 8 is an explanatory diagram showing a relationship between a distance LT from the target object recognition apparatus 10, that is, the vehicle 100 and the signal intensity RT of the light reception signal. Graphs RNav, RNav+σ, RNav+2σ, and RNav+3σ shown in FIG. 8 show a distribution range of a reflected signal due to a raindrop which is a cause of noise to be removed in the noise removal processing. Graphs BCav, BCav−σ, and BCav−2σ indicate a distribution range of a reflected signal, which is not noise, from a black vehicle, which is an example of a detection target that may be difficult detect visually at night.

Here, “a” in each graph is a standard deviation of the intensity distribution of the reflected light from the raindrop or the black vehicle. Depending on a size of the raindrop, a positional relationship between the laser light emitted from the light emitting device 72 and the raindrop, and the like, the intensity of the reflected light from the raindrop is not uniform and varies even when the distance to the raindrop is constant, and can be statistically perceived as a distribution in a certain range. The graph RNav indicates an upper limit of a reflected light distribution range where the intensity of the reflected light from the raindrop is up to an average value. Similarly, the graph RNav+3σ indicates an upper limit of a reflected light distribution range up to three times the standard deviation σ. In other words, if the distribution of the reflected light from the raindrop is a normal distribution, it can be said that a probability that the intensity of the reflected light is within a range whose upper limit is RNav+σ is about 67%, a probability of being within a range whose upper limit is RNav+2σ is about 95%, and a probability of being within a range whose upper limit is RNav+3σ is about 99.7%.

The intensity of the reflected light from the detection target such as a black vehicle is also statistically perceived as a distribution in a certain range, and since the detection target is a target desired to be detected, it is necessary to consider the distribution on a side where the intensity of the reflected light is weak. In order to correctly detect weak reflected light from the detection target such as a black vehicle, it is studied what distribution the reflected light having a low signal intensity among the reflected light from the detection target has. The graph BCav in FIG. 8 indicates a lower limit of the range where the reflected light having a reflected light intensity up to the average value from the detection target is distributed. Similarly, the graph BCav+2σ indicates a lower limit of the distribution range of the reflected light up to twice the standard deviation σ of a low reflected light intensity side. In other words, if the distribution of the reflected light from the detection target is a normal distribution, it can be said that a probability that the intensity of the reflected light is within a range whose lower limit is the graph BCav+σ is about 67%, and a probability of being within a range whose lower limit is the graph BCav+2σ is about 95%. Although not shown in FIG. 8, if a range whose lower limit is the graph BCav+36 is considered, it can be said that a probability that the intensity of the reflected light from the detection target is within such a range is about 99.7%.

For a signal desired to be removed as noise, such as the reflected light from the raindrop, a distribution on a side where the signal intensity is high is taken into consideration among a variation in the reflected light from the raindrop, and meanwhile, for a signal desired to be handled as the detection target, such as a black vehicle, the distribution on the side where the signal intensity is low is taken into consideration, and a condition under which the two cases can be separated is studied. As shown in FIG. 8, in the intensity distribution of the reflected light from the raindrop to be determined as noise, an appearance range is rapidly narrowed as the distance LT from the vehicle 100 increases, and becomes substantially constant signal intensity RT or less at a certain or longer distance. On the other hand, as the distance LT from the vehicle 100 decreases, an appearance range of the signal intensity RT of the reflected light from the detection target that is not to be determined as noise has a widened distribution range on a side where the signal intensity RT is high. Therefore, the first distance threshold TL1 and the second distance threshold TL2 are set as an upper limit distance and a lower limit distance of a range where the distribution range of the intensity of the light reception signal caused by reflection due to the raindrop can be distinguished from the distribution range of the intensity signal caused by reflection due to the detection target by a magnitude of the signal intensity RT, as shown in the drawing. As an example, the second distance threshold TL2 can be assumed to be about 2 to 4 m, and the first distance threshold TL1 can be assumed to be about 8 to 10 m, which may be determined by experiment or simulation. On the other hand, the small threshold TrS and the large threshold TrL are thresholds for distinguishing the distribution range of the intensity signal caused by reflection due to the raindrop from the distribution range of the intensity signal caused by reflection due to the detection object, and when there is an echo TSn behind, the large threshold TrL is set to a value higher than the graph RNav+3σ when the distance LT is between the second threshold Th2 and the first threshold Th1 such that the echo TSn generated by the reflected light from the raindrop is reliably determined as noise. When there is no echo TSn behind, the small threshold TrS is set to a value substantially equal to the graph RNav+3σ when the distance LT is between the second threshold Th2 and the first threshold Th1 such that the echo TSn is less likely to be erroneously determined as noise. As an example, there are
Condition 1: when the focused echo TSn is closer to the second distance threshold TL2 and there is no echo behind, or when the focused echo TSn is between the second distance threshold TL2 and the first distance threshold TL1 and there is no echo behind,
the small threshold TrS is determined to have a magnitude with which the distribution RNav+2σ of the signal due to the raindrop can be distinguished from the distribution BCav−2σ of the signal from the black vehicle, and
Condition 2: when the focused echo TSn is between the second distance threshold TL2 and the first distance threshold TL1, and there is an echo behind, the large threshold TrL is determined to have a magnitude with which the distribution RNav+3σ of the signal due to the raindrop can be distinguished from the distribution BCav−2σ of the signal from the black vehicle.

As a result, the echo TSn is determined as follows.
[1] If the distance from the vehicle 100 is equal to or larger than the first distance threshold TL1 (for example, 10 m), the echo TSn is determined as not being noise and is not removed (step S332),
[2] when the distance from the vehicle 100 is smaller than the first distance threshold TL1 and equal to or larger than the second distance threshold TL2, a comparison is performed with the threshold differing depending on whether there is an echo behind (the small threshold TrS or the large threshold TrL), if the peak intensity is smaller than the threshold, the echo TSn is determined as noise and removed (steps S332 to S338), and if the peak intensity is larger than the threshold, the echo TSn is determined as not being noise and is not removed (steps S332 to S337),
[3] if there is an echo behind and the distance from the vehicle 100 is less than the second distance threshold TL2, the echo TSn is determined to be noise and removed (steps S332, S333, S334, and S338), and
[4] if there is no echo behind and the distance from the vehicle 100 is less than the second distance threshold TL2, a comparison is performed with the small threshold TrS (steps S332, S333, S335, and S337), if the peak intensity is less than the threshold, the echo TSn is determined as noise and removed (step S338), and if the peak intensity is larger than the small threshold TrS, the echo TSn is determined as not being noise and is not removed (steps S337 and S339).

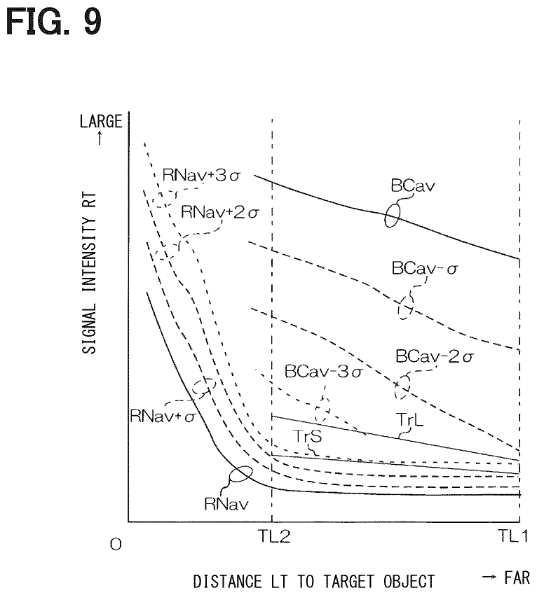

As a result, the reflected light from the raindrop in the vicinity (within the second threshold Th2) of the vehicle 100 is removed as noise if there is no echo behind, and it is determined whether the echo is to be removed as noise according to a magnitude of the small threshold TrS if there is an echo behind, and whether the echo TSn from a range separated by a predetermined distance (from the second threshold Th2 to the first threshold Th1) from the vehicle 100 is noise or due to reflected light from the detection target is correctly identified by the small threshold TrS and the large threshold TrL. In the above-described embodiment, the small threshold TrS and the large threshold TrL are constant regardless of the distance LT from the vehicle 100, and may alternatively be set as values that decrease progressively as the distance LT increases, as shown in FIG. 9. This is because a reflection intensity of the raindrop is small enough to be distinguishable from a reflection intensity from the detection target when the distance LT is equal to or larger than the second threshold Th2, but tends to decrease according to the distance LT. In this way, it is possible to further increase noise identification accuracy when the detection distance LTn corresponding to the echo TSn is equal to or larger than the second threshold Th2 and less than the first threshold Th1. Although not shown, if it does not rain, there is no large difference between the distribution of the reflected light in a region equal to or less than the second distance threshold TL2 and the distribution from the second distance threshold TL2 to the first distance threshold TL1, and the distribution of the noise slightly spreads to a high intensity side. Accordingly, when it does not rain, a clutter noise hardly occurs, and the noise can be removed by the above-described algorithm (FIG. 7). In the above-described determination, the small threshold TrS and the large threshold TrL are determined based on the intensity distribution of the reflected light from the raindrop and the intensity distribution of the reflected light from the black vehicle. It is considered that a signal due to any reflected light falls within each distribution range with a predetermined probability, and in reality, a large reflected signal may be caused by the raindrop exceptionally. When there is such an echo having an exceptionally high intensity, it may be determined that the echo is not noise in the determination shown in FIG. 7, and since such an echo is an isolated point, the echo is removed as noise by the second noise removal processing described below.

### (A4) Second Noise Removal Processing:

Next, the second noise removal processing (step S340) performed after the first noise removal processing (step S330 in FIG. 4) will be described. The second noise removal processing is processing for removing the echo TSn as noise when the echo TSn is from an isolated point. When it is determined that the echo TSn is not the target of the first noise removal processing (step S320: “NO”), or when it is determined that the echo TSn is from a position farther than the first threshold Th1 in the first noise removal processing shown in FIG. 7 and is to be handled as the reflected light from the detection target (step S332: “NO”), the echo TSn is removed as noise if the echo TSn is determined as an isolated point by the second noise removal processing (step S340). If it is determined that the echo TSn is not an isolated point by the second noise removal processing, the echo TSn is finally handled as the reflected light from the target object.

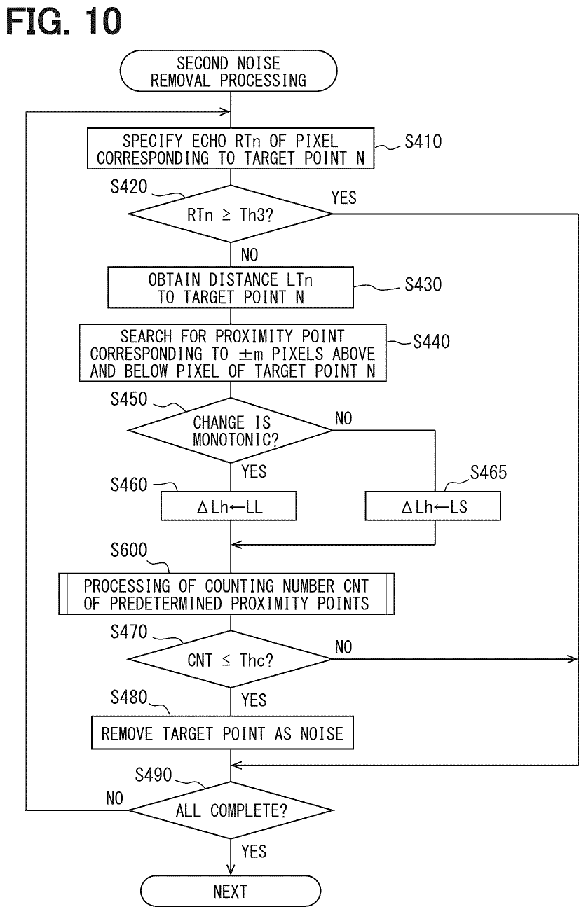

An example of the second noise removal processing will be described with reference to a flowchart in FIG. 10. In the second noise removal processing, the following processing (steps S410 to S490) is sequentially performed for all pixels belonging to the predetermined range SCA with the upper left of the predetermined range SCA scanned by the target object recognition apparatus 10 serving as an origin. A pixel that is a target to be processed is referred to as a target point N (initial value 1). When the processing is started, first, data stored in the storage apparatus 50 for the pixel corresponding to the target point N is read, and the peak intensity RTn of reflected light from the pixel corresponding to the target point N is specified (step S410). The peak intensity RTn is the signal intensity of the echo TSn that is not determined to be noise.

Next, it is determined whether the peak intensity RTn of the reflected light of the target point N is equal to or less than a third threshold Th3 (step S420). The third threshold Th3 is, for example, larger than the second threshold Th2, and is set as a threshold of a level at which it is determined whether the reflected light is to be handled as meaningful reflected light even when the target point N is an isolated point. When the peak intensity RTn of the echo TSn is equal to or less than the third threshold Th3 (step S420: “YES”), the following processing is performed to determine whether the target point N is an isolated point. First, the detection distance LTn to the target point N, which is the target to be determined, is acquired (step S430). Next, a proximity point corresponding to ±m pixels above or below the pixel of the target point N is searched for (step S440).

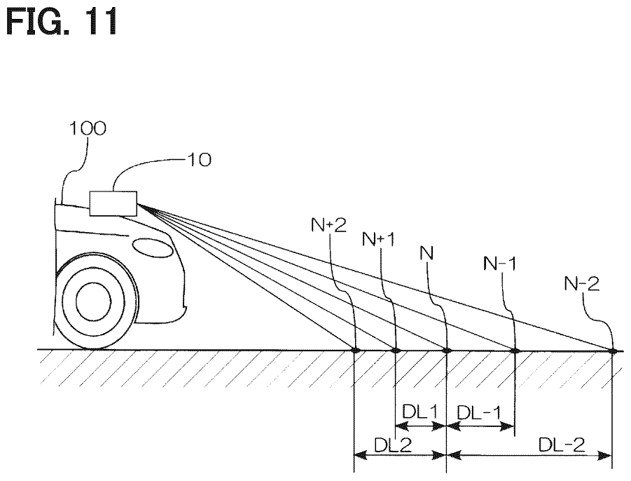

The proximity point above or below the pixel means being above or below the predetermined range SCA in FIG. 1, and as shown in FIG. 11, when it is assumed that reflected light from a road surface is detected, the proximity point is a proximity point in terms of a distance as viewed from the vehicle 100. Of course, when reflected light from a ceiling of a tunnel is detected, upper and lower proximity points as viewed from the vehicle 100 are proximity points close to and far from the vehicle 100. FIG. 11 shows an example in which four proximity points of −2, −1, +1, and +2 are found in a vertical direction as the proximity points of the target point N. In step S440, the proximity points in the vertical direction are searched for, and proximity points in a lateral direction (X-axis direction in FIG. 1) may also be searched for. Of course, not only a proximity point in one of the X-axis direction and the Z-axis direction but also a proximity point in any direction in an X-Z plane may be searched for. The search direction is not limited to one, and there may be multiple search directions. In addition, m may be a value of 1 or a value of 3 or more. It may not be ±m from the target point and may be m in a specific direction from the target point.

After the search for ±m proximity points of the pixel of the target point N, it is determined whether a change in a distance between the target point and each proximity point arranged in the vertical direction is a monotonic increase or a monotonic decrease (step S450). If the change is monotonic (step S450: “YES”), a first distance threshold LL is set as a distance threshold ΔLh (step S460), and if the change is not monotonic (step S450: “NO”), a second distance threshold LS smaller than the first distance threshold is set as the distance threshold ΔLh (step S465). The distance threshold ΔLh is referred to in predetermined proximity point counting processing (step S600) performed subsequently.

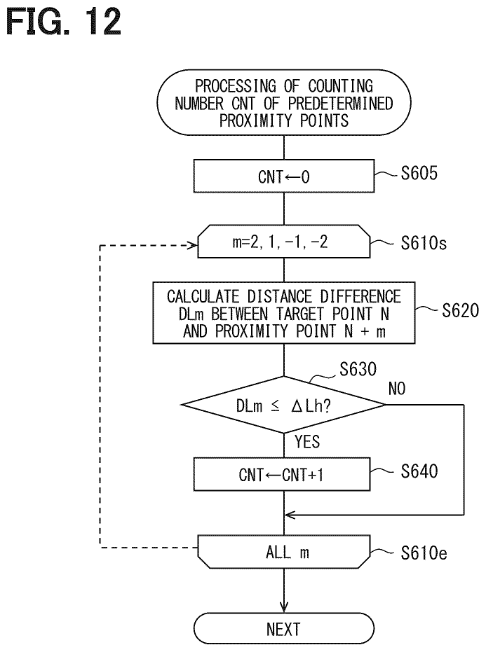

Details of the predetermined proximity point counting processing (step S600) will be described with reference to a flowchart in FIG. 12. In such processing, after a value of a counter CNT is initialized to 0 (step S605), the processing is repeated m−1 times while the variable m indicating the proximity point is decremented (steps S610s to S610e). In the present embodiment, the processing of steps S620 to S640 is repeated with m=2, 1, −1, and −2. First, a distance difference DLm between the target point N and a proximity point N+m is calculated (step S620). FIG. 11 shows the distance difference DLm between the target point N and a proximity point N+1. Next, it is determined whether the distance difference DLm is equal to or less than the distance threshold ΔLh set in the previous processing (step S460 or S465) (step S630), and if the distance difference DLm is equal to or less than the distance threshold ΔLh, it is determined that the two points are proximate to each other, and the counter CNT is incremented by a value of 1 (step S640). If the distance difference DLm is larger than the distance threshold ΔLh, the counter CNT is not incremented.

The above-described processing is repeated by changing the variable m, and after the processing of performing determination for all variables m and incrementing or not incrementing the counter, the processing exits to “NEXT”, and the present processing routine is ended. Then, returning to the second noise removal processing shown in FIG. 10, it is determined whether the value of the counter CNT is equal to or less than a predetermined number-of-points threshold Thc (step S470), and if the value of the counter CNT is equal to or less than the number-of-points threshold Thc, the target point N is removed as noise (step S480). On the other hand, if the value of the counter CNT is larger than the number-of-points threshold Thc (step S470: “NO”), it is determined that the target point N cannot be determined as noise, and nothing is performed.

In addition to when it is determined that the peak intensity RTn of the echo TSn is equal to or larger than the third threshold Th3 (step S420: “YES”), when the target point is removed as noise (step S480), or when the value of the counter CNT is larger than the number-of-points threshold Thc (step S470: “NO”), the processing proceeds to step S490, it is determined whether the second noise removal processing of removing the isolated point for all pixels in the predetermined range SCA is completed (step S490), and the processing of steps S410 to S490 is repeated until the processing is completed. When the second noise removal processing is completed for all pixels, the processing exits to “NEXT” and ends.

In this way, if the distance to the proximity point in the vicinity of the target point N monotonically increases or monotonically decreases, even when the distance difference to the proximity point is large, the point is counted as a proximity point, and on the other hand, if the distance to the proximity point in the vicinity of the target point N does not monotonically increase or monotonically decrease, the point is counted as a proximity point only when the distance difference to the proximity point is small. As a result, in the determination of the isolated point, it is possible to consider presence of a target object, such as a road surface or a wall, whose points continuing in a predetermined direction are likely to be continuous. The number-of-points threshold Thc used for the determination in step S470 may be a uniform value or a value corresponding to the distance. It is considered that the value corresponding to the distance is set to a smaller value as the distance to the target point N increases. The number-of-points threshold may be a function of the distance, or may be switched between multiple stages such as two stages or three stages before and after a predetermined distance. A magnitude of the number-of-points threshold may be all points (2·m if m=2), or may be a value of about 80% thereof.

Thereafter, the target object recognition processing (step S500) shown in FIG. 4 is performed for a point where there is reflected light except for that to be removed as noise. In the target object recognition processing, first, the detection distance LTn to the target point N is calculated based on detection timing of the reflected light at each target point N, and alternatively, if the detection distance LTn is already calculated and stored in the storage apparatus 50, the detection distance LTn is read, and the detection target OJT is recognized based on the distance to the target point N. Specifically, target object recognition such as extraction of a road surface, recognition of a lane line, or clustering or tracking of a target is performed, using a detection point from which the noise is removed and the proximity point proximate to the detection point.

According to the noise removal apparatus 30 according to the first embodiment described above, a clutter noise caused by a raindrop, dust, or the like can be removed, using the echo intensity and the detection distance. Instead of simply removing an isolated point having a different detection distance from a neighboring point, a point having a specific arrangement relationship is not regarded as noise, and thus it is possible to perform flexible determination in which an isolated point that is not a target object is removed as noise whereas a lane line or the like is not removed. As a result, it is possible to distinguish between a raindrop in rain and the detection target OJT such as a black-painted vehicle, and it is possible to reduce a possibility of overlooking the detection target OJT.

### B. Second Embodiment

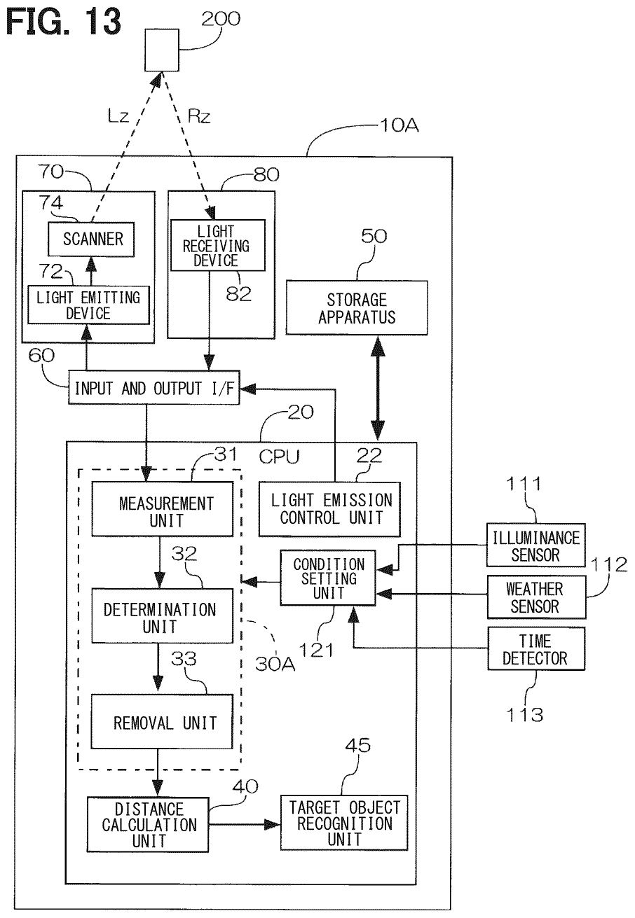

FIG. 13 shows a schematic configuration of a target object recognition apparatus 10A including the noise removal apparatus 30 according to a second embodiment. As shown in the drawing, the target object recognition apparatus 10A has substantially the same configuration as the target object recognition apparatus 10 according to the first embodiment, and is different in that internal processing of a noise removal apparatus 30A is different, that various sensors for detecting an environmental condition are provided for the processing, and that a calibration unit for calibrating the light receiving unit 80 is further provided.

In the second embodiment, a condition setting unit 121 is provided inside the CPU 20. The condition setting unit 121 is implemented by the CPU 20 by executing a program to be described later, similarly to the noise removal apparatus 30A and the like. The condition setting unit 121, and an illuminance sensor 111, a weather sensor 112, a time detector 113, and the like for detecting the environmental condition are connected. The illuminance sensor 111 detects brightness (illuminance) of an environment of the target object recognition apparatus 10A. The illuminance may be detected as an analog value, or may be detected as an index indicating multiple levels such as “bright”, “dim”, “dark”, and “pitch dark”.

The weather sensor 112 is a sensor that detects a weather condition such as “sunny”, “cloudy”, and “rainy”. The weather sensor 112 may be implemented by a combination of sensors detecting illuminance, a raindrop, or the like, or may be connected by wireless communication to a site or the like, which detects and provides a regional weather condition in response to a detection request, to acquire the weather condition. The time detector 113 can be implemented more easily by a real-time clock or the like, and may be configured to acquire time information in an external reference clock, for example, a GPS, or to acquire the time from a radio clock.

The following description will be performed in which it is assumed that these three sensors are provided in the embodiment, and alternatively, there may be one sensor or two. Another necessary sensor that detects the environment where the vehicle 100 is located may be provided, such as a humidity sensor, a wind speed sensor, a snowfall detector, a fog or gas detector, or a sensor that detects a situation of road surface submersion using reflected light.

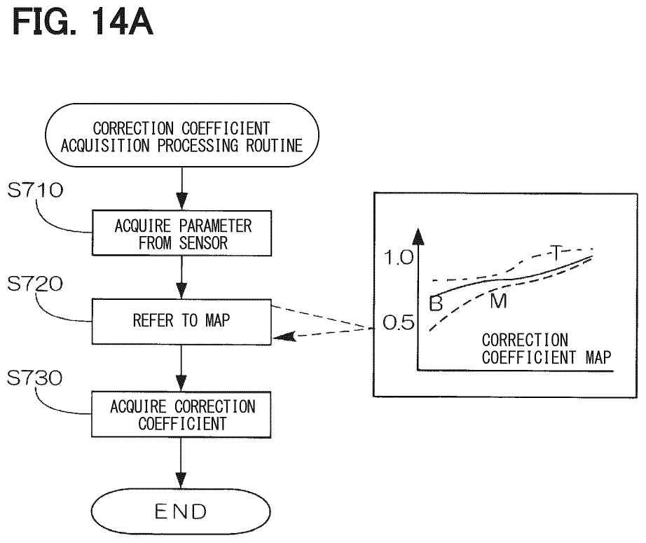

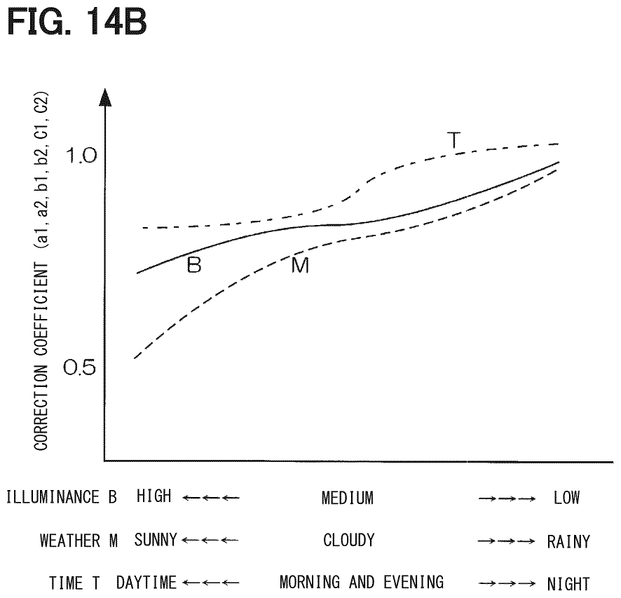

An operation of the condition setting unit 121 will be described. FIG. 14A is a flowchart showing a correction coefficient acquisition processing routine implemented by the condition setting unit 121. As will be described later, the condition setting unit 121 acquires a correction coefficient from the environmental condition, and corrects a noise removal determination condition of the noise removal apparatus 30A, using the correction coefficient.

When the correction coefficient acquisition processing shown in the drawing is started, first, parameters are acquired from the various sensors 111 to 113 connected to the condition setting unit 121 (step S710). The parameters are illuminance B from the illuminance sensor 111, weather information M from the weather sensor 112, and a time T from the time detector 113. After the parameters are acquired, processing is performed to acquire the correction coefficient with reference to a map (step S720). A concept of the map to be referred to is shown in FIG. 14B. The shown map is conceptual, and a relationship between an actual parameter and the correction coefficient may be determined experimentally or empirically.

In this example, multiple correction coefficients a1, a2, b1, b2, c1, and c2 are acquired for the illuminance M, the weather M, and the time T. Significance and a use form of the correction coefficients will be described later, it is not necessary to acquire all the correction coefficients, and a part of the correction coefficients may be acquired using the map. In the shown example, a value of the correction coefficient increases as the illuminance B decreases, the value of the correction coefficient decreases as the illuminance B increases, the value of the correction coefficient increases as the weather M approaches a rainy side, the value of the correction coefficient decreases as the weather M approaches a sunny side, the value of the correction coefficient increases as the time T approaches night (0 o'clock in display of 24 hours), and the value of the correction coefficient decreases as the time T approaches daytime (12 o'clock in the display of 24 hours). In this example, the value of the correction coefficient for each parameter is shown in an analog manner, and the correction coefficient may alternatively be a map that has a constant value for a predetermined range of the parameter. When multiple parameters are used, multiple correction coefficients corresponding to the parameters are obtained, and it is sufficient that a smallest value among the multiple correction coefficients is used. In this way, the correction coefficient can be set based on a condition having a strongest influence. Of course, it is also possible to handle by using an average value or the like, and when there are three or more correction coefficients, it is also possible to use a median value.

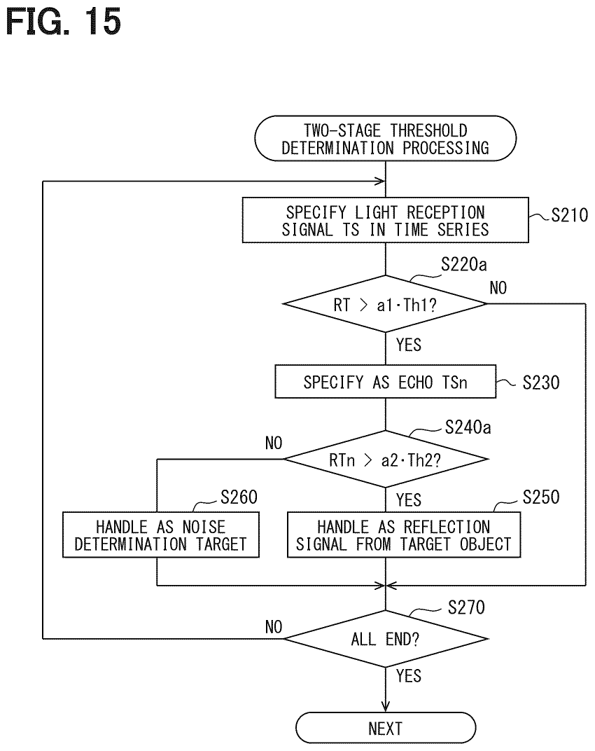

Next, application of the correction coefficient will be described. FIG. 15 is a flowchart showing a processing routine in the second embodiment corresponding to the two-stage threshold determination processing shown in FIG. 5 in the first embodiment. Each step corresponds to and is the same as that in FIG. 5, except for steps S220a and S240a to each of which a suffix a is attached. Such steps are different from those in the first embodiment in that the first threshold Th1 is multiplied by the correction coefficient a1 in step S220a and the second threshold Th2 is multiplied by the correction coefficient a2 in step S240a. Therefore, for example, when the illuminance B is high, when the weather M is sunny, or when the time T is daytime, the correction coefficients a1 and a2 are values smaller than 1.0. As a result, a signal intensity range (see FIG. 6B) in which it is determined that the echo having the signal intensity RT is to be handled as a noise determination target (step S260) is set to a low intensity range. The correction coefficients a1 and a2 do not need to have the same value, and the set signal intensity range (Th1 to Th2) can be widened or narrowed. Alternatively, only one of the correction coefficients a1 and a2 may be determined based on the illuminance B or the like, and the other may be maintained at a fixed value. In any case, it is possible to more freely set the range of whether to handle as a noise determination target based on parameters such as the illuminance B, the weather M, and the time T. Of course, one or two of the illuminance B, the weather M, and the time T may be used to set the correction coefficients a1 and a2.

In this way, the same operational effect as that in the first embodiment, that is, narrowing down the noise determination target by a two-stage threshold, can be obtained, and the determination of whether the detected echo is a noise determination target can be more appropriately performed by the noise determination processing (step S260) according to the environment where the target object recognition apparatus 10A is located.

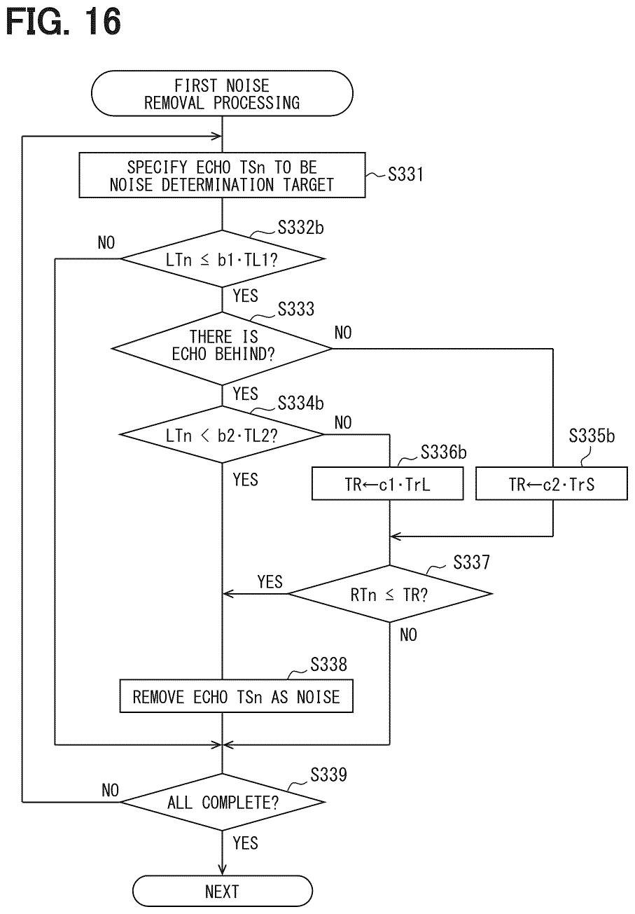

Similarly, the first distance threshold TL1, the second distance threshold TL2, the small threshold TrS, and the large threshold TrL in the first noise removal processing may be corrected based on the illuminance B, the weather M, the time T, and the like. This example is shown in FIG. 16. FIG. 16 is a flowchart showing a processing routine in the second embodiment corresponding to the first noise removal processing shown in FIG. 7 in the first embodiment. Each step corresponds to and is the same as that in FIG. 7, except for steps S332b, S334b, S335b, and S336b to each of which a suffix b is attached. The second embodiment is different from the first embodiment in that the first distance threshold TL1 is multiplied by the correction coefficient b1 in step S332b, the second distance threshold TL2 is multiplied by the correction coefficient b2 in step S334b, the small threshold TrS is multiplied by the correction coefficient c1 in step S335b, and the large threshold TrS is multiplied by the correction coefficient c2 in step S336b.

Setting of the correction coefficients b1, b2, c1, and c2 based on the parameters such as the illuminance B, the weather M, and the time T is the same as the correction coefficients a1 and a2 in the two-stage threshold determination processing (FIG. 15). As in the case of the two-stage threshold determination processing (FIG. 15), it is possible to perform various settings, for example, regarding the fact that it is not necessary to set all the correction coefficients, any of the illuminance B, the weather M, and the time T may be used, in terms of a setting method when using multiple thereof, and in terms of a magnitude relationship between the parameter such as the illuminance B and the correction coefficient b1.

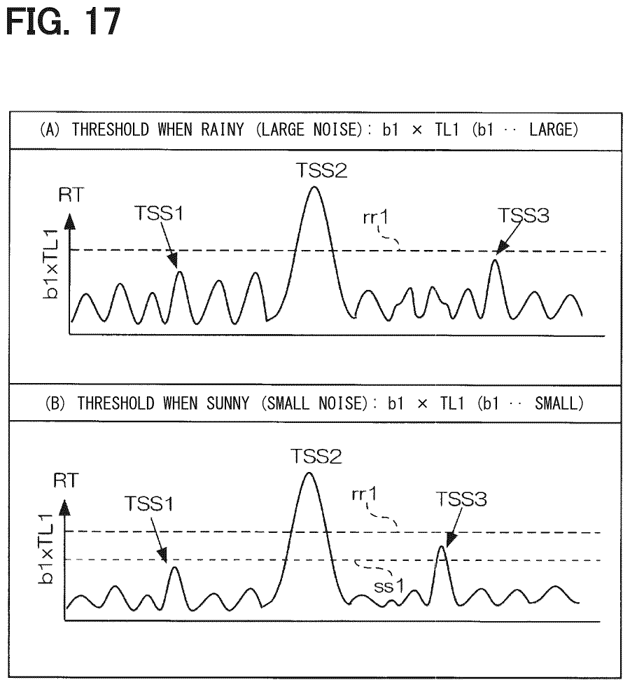

FIG. 17 shows an example of how noise determination is performed by the processing shown in FIG. 16. An upper part of the drawing shows a case of a rainy weather, and a lower part shows a case of a sunny weather. In a table shown in FIG. 14B, the correction coefficient b1 is set to a value close to 1.0 in the case of the rainy weather, and is set to a smaller value in the case of the sunny weather. Therefore, a threshold b1×TL1 used for determination in step S332b is set to a broken line rr1 in the drawing in the case of the rainy weather, and to a broken line ss1 lower than the broken line rr1 in the drawing in the case of the sunny weather. As a result, assuming a case where echoes TSS2, TSS3, and TSS1 are contained in a signal in a descending order, the threshold is set to be high in rainy weather such that the clutter noise TSS3 caused by a raindrop can be removed, and the threshold is set to be relatively low in sunny weather such that the echo TSS3 from the target object can be detected.

In this way, if the first distance threshold TL1, the second distance threshold TL2, the small threshold TrS, and the large threshold TrL in the first noise removal processing are corrected based on a table 2 shown as an example in FIG. 14B by using the illuminance B, the weather M, the time T, and the like as parameters, the same operational effect as that in the first embodiment can be obtained according to the environment where the target object recognition apparatus 10A is located, and further, it is possible to perform more appropriate noise removal.

### C. Third Embodiment

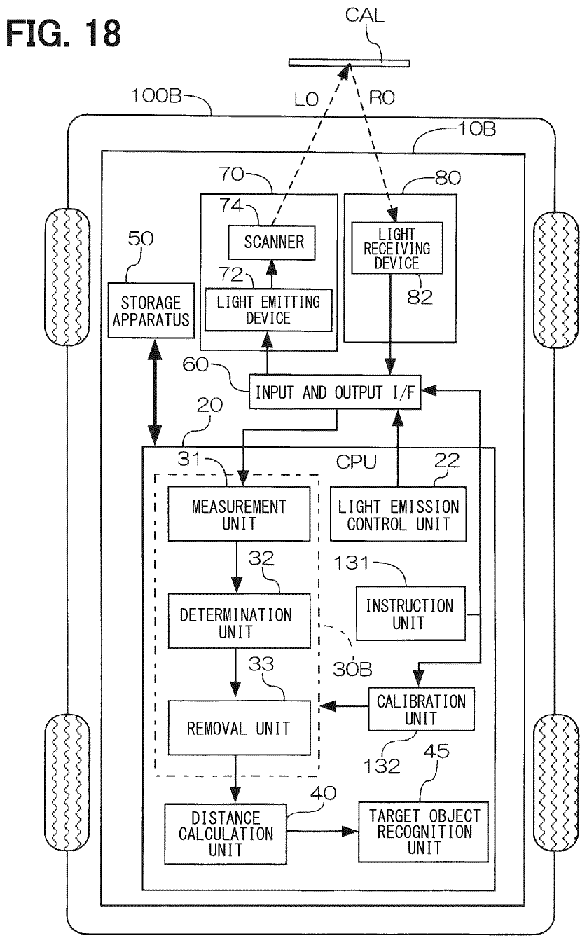

Next, a third embodiment will be described. As shown in FIG. 18, a target object recognition apparatus 10B according to a third embodiment is provided in a vehicle 100B. The target object recognition apparatus 10B has a configuration similar to that of the target object recognition apparatus 10 according to the first embodiment, and is different in that a calibration unit 130 and an instruction unit 131 are provided, and that there is calibration processing to be described later in processing by a noise removal apparatus 30B. In this embodiment, when the instruction unit 131 receives an instruction from a user and outputs an instruction to perform the calibration processing, the calibration unit 130 causes the noise removal apparatus 30B to perform the calibration processing, and drives the light emitting unit 70 via the input and output interface 60 for the calibration processing. Hereinafter, the calibration processing will be described.

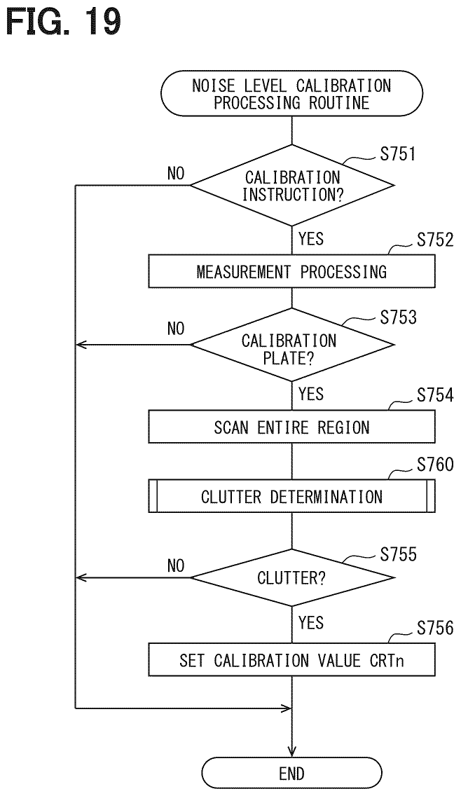

FIG. 19 is a flowchart showing a noise level calibration processing routine. In such processing, a determination condition under which it is determined that there is an echo having an intensity equal to or larger than a predetermined intensity, that is, the signal is not noise, is set based on characteristics of a measurement unit that measures the signal in the noise removal apparatus, that is, the light receiving unit 80 herein. Prior to execution of the shown processing, a user of the vehicle 100B parks the vehicle 100B in a place where a calibration plate CAL is grounded, such as a garage. The calibration plate CAL is for calibrating characteristics of the light emitting unit 70 and the light receiving unit 80, and is a plate uniformly painted in a color having a high reflectance, for example, white. The user of the vehicle 100B provides such a calibration plate CAL on a wall or the like in the front at the time of parking.

When the shown noise level calibration processing is started, it is first determined whether input of a calibration instruction is received (step S751). When the user operates the instruction unit 131, the noise removal apparatus 30B determines that the input of the calibration instruction is received, and performs measurement processing (step S752). Specifically, a laser pulse is output to a measurable range using the light emitting unit 70, and the measurement unit 31 detects reflected light using the light receiving unit 80. When the instruction unit 131 is operated and the measurement processing is performed after a front side of the vehicle 100B is stopped at a position facing the calibration plate CAL, light received by the light receiving unit 80 is reflected light from the calibration plate CAL of the uniform white color and is from a certain distance.

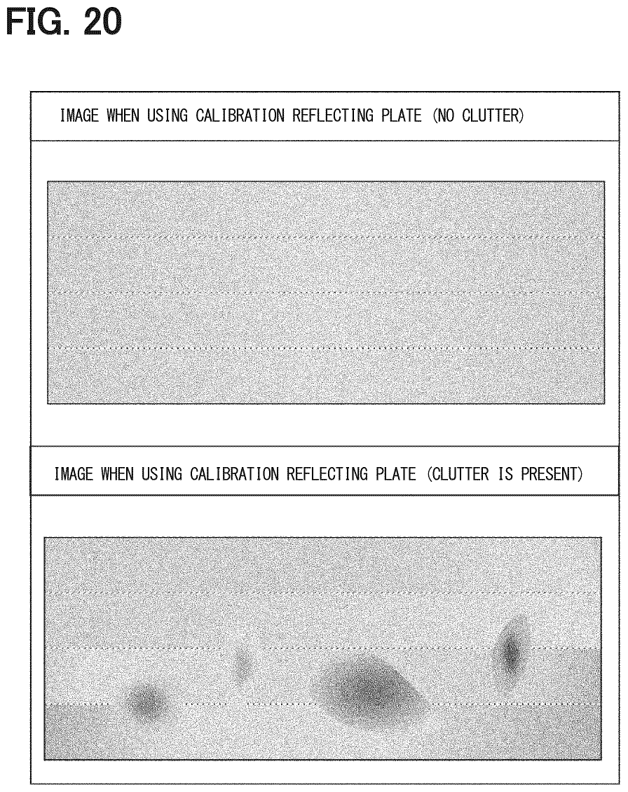

Focusing on this point, it is determined whether the reflected light from the calibration plate CAL is detected (step S753). If a detected target object is from a uniform distance, the target object is determined to be the calibration plate CAL, and if the target object is not from the uniform distance, the target object is determined as not being the calibration plate CAL. When it is determined that the target object is the calibration plate CAL, an entire region thereof is scanned (step S754). In a case where the reflected light from the calibration plate CAL is detected, since total reflection due to the uniform white color at the uniform distance is detected, if an intensity of a laser light pulse emitted from the light emitting unit 70 is constant regardless of a scanning position and sensitivity of light reception by the light receiving unit 80 is constant regardless of a light reception position, it is expected to obtain a uniform image. An image obtained under such an ideal condition is shown in an upper part of FIG. 20.

On the other hand, an actually obtained image is an uneven image as shown in a lower part of FIG. 20. This is because the intensity of the laser light pulse emitted from the light emitting unit 70 is not uniform depending on the scanning position, and the sensitivity of light reception by the light receiving unit 80 may be different depending on the light reception position. This is not due to a raindrop or the like, but is a clutter caused by hardware, which does not differ each time when measurement is performed and has reproducibility. Even when sensitivity of each light receiving device is adjusted such that there is no clutter at the time of delivery, the clutter may occur due to a change over time or the like. Therefore, a content of the clutter is determined and it is determined whether the clutter is caused by hardware (step S760), and when it is determined that there is a clutter caused by hardware (step S755: “YES”), a calibration value CRTn is set (step S756), and the present routine is ended.

The calibration value CRTn is a threshold set corresponding to the scanning position, and the calibration value CRTn is subtracted from the peak intensity RTn of the echo TSn detected by the light receiving unit 80 when obtaining the peak intensity RTn of the reflected light. The peak intensity RTn of the echo TSn in the two-stage threshold determination processing (FIGS. 5 and 15), the first noise removal processing (FIGS. 7 and 16), and the second noise removal processing (FIG. 10) is a value obtained by subtracting the calibration value CRTn from the peak intensity RTn detected by the light receiving unit 80.

In this way, it is possible to remove or reduce an influence of the clutter caused by unevenness of hardware sensitivity or the like generated in the light receiving unit 80 or the like. Such calibration processing may be performed at the time of factory delivery of the vehicle 100B or the target object recognition apparatus 10B, or may be performed at the time of vehicle inspection or the like. The calibration plate CAL may be provided as an accessory, and the user may set the calibration plate CAL in parking and perform the calibration processing periodically or at any timing.

In the above-described embodiment, the calibration value CRTn is set to detect an occurrence location of the clutter and reduce the influence of the clutter, and if it is known, as the characteristics of the light emitting unit 70 and the light receiving unit 80, that a light emission intensity of the light emitting unit 70 in the vicinity of left and right ends of a measurement range is low, for example, the calibration value CRTn in the vicinity of the left and right ends of the measurement range may be set to a small value or a negative value without measurement. In this way, it is possible to prevent a decrease in detection sensitivity in the vicinity of the left and right ends of the measurement range. Such correction is not limited to the vicinity of the left and right ends, and may be performed at a location necessary for the characteristics of the light emitting unit 70 and the light receiving unit 80. In the above-described embodiment, the sensitivity is corrected by setting the value of the calibration value CRTn and subtracting the calibration value CRTn from the peak intensity RTn of the detected echo TSn, and the first and second thresholds Th1 and Th2 to be compared with when detecting the echo may be corrected according to a clutter intensity or a location of the measurement range.

### D: Fourth Embodiment

Next, a fourth embodiment will be described. The target object recognition apparatus 10 and the noise removal apparatus 30 according to a fourth embodiment have the same hardware configuration as that in the first embodiment, and only a part of processing performed by the noise removal apparatus 30 is different. In the first embodiment, it is determined whether the echo TSn in the light reception signal is handled as the reflection signal from the target object instead of the noise (step S250) or whether the echo TSn is the target of the noise-or-not determination (step S260) by the two-stage threshold determination processing (FIG. 5). In the fourth embodiment, the following processing is additionally performed in order to reduce the echoes TSn to be regarded as the target of the noise-or-not determination.

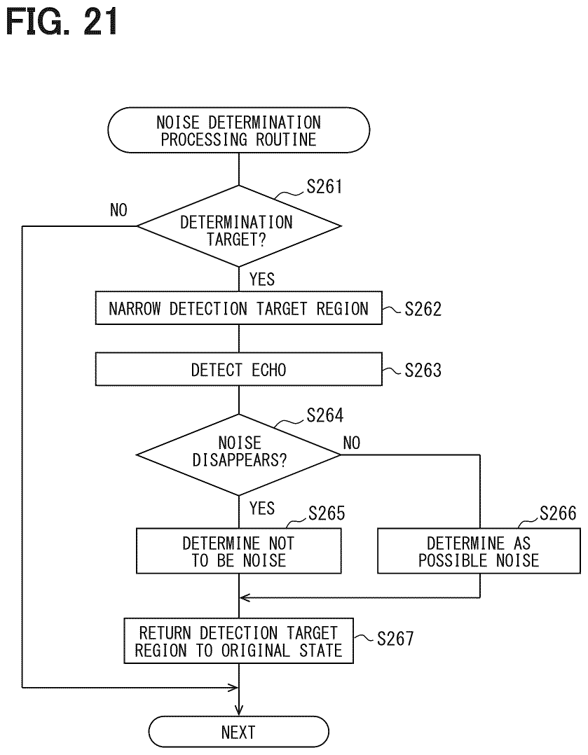

A noise determination processing routine additionally performed by the noise removal apparatus 30 is shown in a flowchart in FIG. 21. The processing shown in FIG. 21 corresponds to a content of the processing in step S260 in FIG. 5, that is, the processing of “handle as noise determination target”. As shown in FIG. 5, by the two-stage threshold determination processing, it is determined that the echo TSn whose peak intensity RTn is larger than the first threshold Th1 and smaller than the second threshold Th2 is the noise determination target (step S260), and more specifically, as shown in FIG. 21, after confirming that the echo TSn is the noise determination target (step S261: “YES”), the noise removal apparatus 30 performs processing of narrowing a range where the signal is read from the light receiving unit 80, that is, a detection target region ROI of the echo TSn (step S262). In the present embodiment, the processing of narrowing the detection target region ROI is performed by narrowing a range where the measurement unit 31 of the noise removal apparatus 30 reads the light reception signal from the light receiving unit 80. The processing of narrowing the detection target region ROI may also be implemented by directly controlling the light emitting unit 70 and the light receiving unit 80 by hardware.

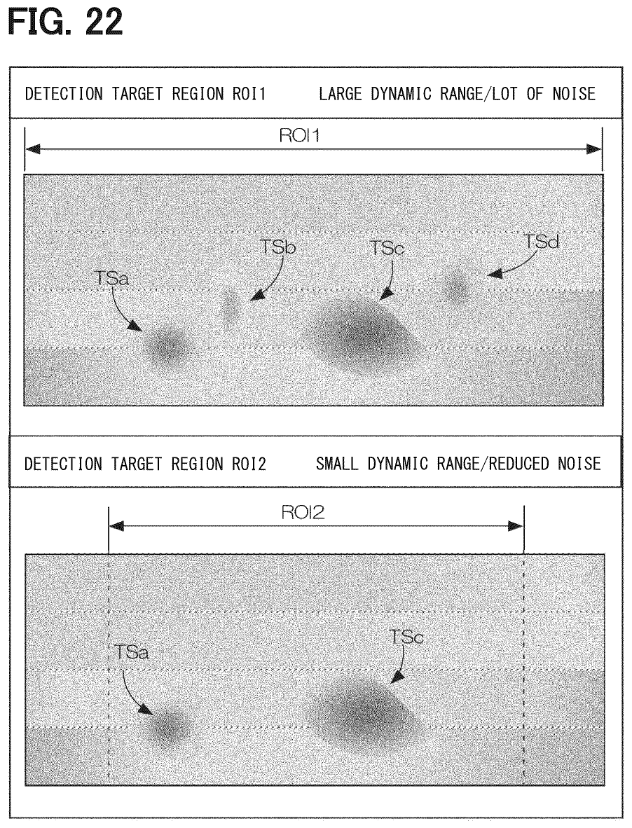

After narrowing the detection target region ROI, the noise removal apparatus 30 performs processing of detecting the echo TSn again (step S263). This state is shown in FIG. 22. An upper part of the drawing schematically shows an example of detection in a normal state before narrowing the detection target region ROI. The detection target region ROI is a maximum range ROI1 in the light receiving unit 80, and at this time, a dynamic range of detection is wide and there is a lot of noise. In appearance, there are four echoes TSa, TSb, TSc, and TSd. Among these echoes, the echoes TSb and TSd are echoes to be handled as noise determination targets by the two-stage threshold determination processing shown in FIG. 5.

In response to this determination, when the detection target region ROI is set to a narrow range ROI2 in step S262 described above and the detection is performed again, as shown in a lower part of FIG. 22, the dynamic range is smaller due to the narrowing of the detection range, and as a result, the echoes TSb and TSd disappear. In this case, since the determination in step S264 is “YES”, that is, it can be determined that the noise disappears, it is determined that there is no noise (step S265). On the other hand, if the noise does not disappear, it is determined that the echoes TSb and TSd may be noise (step S266). Thereafter, processing of returning the detection target region ROI to an original state is performed (step S267), and the present routine ends.

In the fourth embodiment described above, the wide detection target region ROI and the noise removal can both be obtained by switching a size of the detection target region ROI at the time of detecting the echo between wide and narrow and switching the dynamic range between large and small. As a result, it is possible to reduce targets to be subjected to the noise-or-not determination, and to shorten a time required for the processing.

In the present embodiment, when an echo to be subjected to noise determination is found after the two-stage threshold determination processing, the detection target region ROI is switched to a narrow range, and the echo is removed if the echo is noise, and the noise removal by narrowing the detection target region ROI may be performed before the two-stage determination. The width of the detection target region ROI may be switched between wide and narrow each time when measurement is performed, and detection in a case where the detection target region ROI is wide and detection in a case where the detection target region ROI is narrow may be performed as a pair to obtain both the noise reduction and the wide detection target region ROI. Except for the above-described points, the target object recognition apparatus 10 and the noise removal apparatus 30 according to the present embodiment have the same operational effect as that in the first embodiment.

### E. Other Embodiments

(1) The following embodiments may also be implemented as a noise removal apparatus for removing noise generated when a detection target is recognized using reflection of light. The noise removal apparatus includes: a measurement unit configured to measure an intensity of arrival light that arrives from a direction corresponding to an emission direction of light emitted toward a predetermined range along an elapsed time from emission of the light; a determination unit configured to determine, when there is an echo having an intensity equal to or larger than a predetermined intensity in the measured arrival light, whether the echo is reflected by the detection target located in the predetermined range, using the intensity of the echo and a detection distance that is a distance corresponding to the elapsed time; and a removal unit configured to remove, as noise, the echo determined not to be reflected by the detection target. In this way, since the determination is performed using the intensity of the echo and the detection distance that is the distance corresponding to the elapsed time, it is possible to improve accuracy of noise removal without simply determining that an echo having a weak intensity is noise. Here, as the processing, the determination may be performed using the elapsed time equivalent to the detection distance instead of using the detection distance. When it is determined whether the echo is reflected by the detection target located in the predetermined range, using the intensity of the echo and the detection distance that is the distance corresponding to the elapsed time, it may be determined whether the echo is noise by performing a determination combining the intensity of the echo and the detection distance, or it may be determined whether the echo is noise by mapping the intensity of the echo and the detection distance in advance and referring to a map based on the intensity of the echo and the detection distance.

Such an apparatus may be used alone for noise removal, or may be used for target object recognition by outputting a signal after noise removal to a target object recognition apparatus. The light emitted to the predetermined range may be laser light or infrared light from a light emitting diode or the like. The emission to the predetermined range may be performed by scanning light from a point light source over the predetermined range, and the scanning may be performed in a two-dimensional direction. Multiple light emitting units that emit light may be arranged in one direction, and one-dimensional scanning may be performed in a direction intersecting this direction to detect the intensity of the arrival light that arrives from the predetermined range. Further, a large number of light emitting units may be two-dimensionally arranged, and the arrival light from the predetermined range may be detected by emission once.
(2) In such a configuration, when the arrival light measured by the measurement unit includes, as the echo, a first echo and a second echo having the elapsed time longer than that of the first echo, and the first echo is within a predetermined first distance range, the determination unit may determine that the first echo is not reflected by the detection target located in the predetermined range. In this way, when there are multiple echoes in one beam of the arrival light including the first echo and the second echo having the elapsed time longer than that of the first echo, and the first echo is from the predetermined first distance range, it can be determined that the first echo is not reflected by the detection target located in the predetermined range. When there are multiple echoes in the arrival light from a direction corresponding to one emission direction, since it is assumed that there is reflection by a raindrop or the like and reflection of light passing through a raindrop, the first echo is determined to be noise if the first echo that is a nearer echo is within the predetermined first distance range. The first distance range is not uniform depending on where the noise removal apparatus is used, and may be a range of several meters when the noise removal apparatus is mounted on a vehicle, for example. Of course, when a radar dome or the like is provided and used for detection of a long-distance detection target, the first distance range may be a range of about 10 meters or more. The first echo is not limited to being the first among the multiple echoes, and if there are three or more echoes, the above-described determination may be performed with a second echo serving as the first echo and a third echo serving as the second echo. The same applies to the following configurations.
(3) In the configuration of (1) or (2) described above, when the measurement unit detects, as the echo in the arrival light, the first echo and the second echo having the elapsed time longer than that of the first echo, the determination unit may compare an intensity of the first echo with an intensity threshold of a predetermined first value, when the measurement unit does not detect, as the echo in the arrival light, the second echo having the elapsed time longer than that of the first echo, the determination unit may compare the intensity of the first echo with an intensity threshold of a second value smaller than the first value, and when the intensity of the first echo is smaller than the intensity threshold, the determination unit may determine that the first echo is not reflected by the detection target located in the predetermined range. In this way, by changing a magnitude of the intensity threshold to be compared with the intensity of the first echo depending on whether there is the second echo behind the first echo, it is possible to improve accuracy of the determination that the first echo is not reflected by the detection target. This is because there is a high possibility that the first echo is due to reflected light caused by a raindrop or the like when there is the second echo behind, and the intensity of the first echo is compared with the first value larger than the second value set as the intensity threshold when there is no echo behind, thereby increasing a possibility of enabling determination that the echo is not due to the reflected light from the detection target. The first value and the second value set as the intensity threshold may be preset values, and the second value may be determined by a ratio such as 80% of the first value. In addition, the first value and the second value may be changed according to an intensity of background light or the like.
(4) In the configurations of (1) to (3) described above, the measurement unit may detect, as the echo, an echo in the arrival light from a target point that is one point in the predetermined range, and echoes in the arrival light from at least two proximity points proximate to the target point, and when the number of proximity points is equal to or smaller than a predetermined number-of-points threshold, the determination unit may determine that the echo in the arrival light from the target point is not reflected by the detection target located in the predetermined range, the number of proximity points being the number of the proximity points whose distance difference corresponding to a difference between the elapsed time of the echo in the arrival light from the target point and the elapsed time of the echo in the arrival light of each of the proximity points is equal to or smaller than a predetermined distance threshold. In this way, it is possible to accurately determine whether the focused target point is an isolated point or is due to the arrival light from the detection target including the proximity points and is not an isolated point. Of course, whether the target point is an isolated point may be determined by another method. For example, determination may be performed based on whether a change in the detection distance of the target point and a change in the detection distance of the proximity point are synchronized with each other. Alternatively, determination may be performed based on whether there is a certain relationship between a ratio of the intensity of the arrival light from the target point or the proximity point and a ratio of the detection distance.
(5) In the configuration of (4) described above, the target point and the proximity points may be aligned in a predetermined direction, and the predetermined direction may include at least one of a vertical direction component and a horizontal direction component. In this way, when the target point or the proximity point includes the component in the vertical direction or the horizontal direction, the target point or the proximity point can be easily determined as belonging to the detection target. As such a detection target, for example, a road surface, a wall, a lane line, a step, or a guard rail on a road can be assumed. The component in the predetermined direction may be a component in one or both of the vertical direction and the horizontal direction.
(6) In the configuration of (4) or (5) described above, in a state in which the target point and the proximity points are aligned in an order along a predetermined direction, when a first condition that the detection distance corresponding to the elapsed time of the echo in the arrival light from each of the target point and the proximity points monotonically increases or monotonically decreases in the order is satisfied, the determination unit may set the distance threshold, which is compared with the distance difference to obtain the number of proximity points, to a first distance threshold, and in a case except when the first condition is satisfied, the determination unit may set the distance threshold, which is compared with the distance difference to obtain the number of proximity points, to a second distance threshold smaller than the first distance threshold. In this way, it is possible to determine that a linear target point on the detection target such as the lane line is not an isolated point more easily than a case where the proximity points are not aligned in one direction with respect to the target point.
(7) In the configurations of (4) to (6) described above, the number-of-points threshold may be increased or decreased in at least two stages according to a length of the detection distance corresponding to the elapsed time. In this way, by reducing the number-of-points threshold when the target point is far, it is easier to determine that the target point is not an isolated point even when the target point is far. The number-of-points threshold may be set to values of two or more stages in advance and be switched between the set values, or may be increased or decreased by a predetermined ratio.
(8) In the first embodiment described above, as shown in the flowchart in FIG. 10, the first distance threshold LL or the second distance threshold LS is set as the distance threshold ΔLh (steps S450 to S465) depending on whether the detection distance to the target point or the proximity point monotonically increases or decreases, and then the number of points where the distance difference DLm is smaller than the distance threshold ΔLh is counted (FIG. 12) to determine whether the target point is the noise determination target (FIG. 10, step S470). In contrast, as described below, the determination of the number of proximity points may be performed preferentially over the determination that the number of proximity points monotonically increases or decreases. That is, the determination unit may sequentially change the target point, which is one point in the predetermined range, to determine whether the number of proximity points is equal to or smaller than the number-of-points threshold, and even when it is already determined that the number of proximity points is equal to or smaller than the number-of-points threshold for another target point in the predetermined range according to the determination, in a state in which the target point and the proximity points are aligned in an order along a predetermined direction and when the detection distance corresponding to the elapsed time of the echo in the arrival light from each of the target point and the proximity points monotonically increases or monotonically decreases in the order, the determination unit may determine that the echo in the arrival light from the other target point is reflected by the detection target located in the predetermined range. With reference to FIG. 10, the determination in step S450 is moved to be performed after step S470, and if the detection distances of the target point and the proximity points monotonically increase or decrease in this order, the processing in step S480 is not performed. In this way, when the detection distances of the target point and the proximity points monotonically increase or decrease in this order, even when the number of proximity points is small and it is already determined that the echo in the arrival light from the point is not reflected by the detection target located in the predetermined range, it can be determined that the target point is not an isolated point. In the case of the processing order in FIG. 10, when it is determined that the detection distances monotonically increase or monotonically decrease, the determination of the number of proximity points may not be performed. Of course, when the detection distances to the target point and the proximity points monotonically increase or monotonically decrease in this order after the determination of the number of proximity points, a determination result about the number of proximity points may be overrode.
(9) In the first embodiment described above, as shown in FIGS. 5 and 6B, the echo having the signal intensity equal to or larger than the first threshold Th1, which is the lower limit value, and less than the second threshold Th2, which is the upper limit value, is determined to be the noise determination target (steps S220 and S240 in FIG. 5), and the determination may be performed regarding only the second threshold value Th2 that is the upper limit value. In this case, the determination unit may compare the intensity of the echo in the arrival light with an upper limit value that is a predetermined intensity threshold, and exclude the echo from a target of the determination when the intensity of the echo is equal to or larger than the upper limit value. In this way, the number of echoes that are noise determination targets can be reduced by simple determination, and thus noise determination processing can be speeded up. In addition, the intensity may be determined based on a peak value, or may be determined based on a width (for example, a width at a half value) of the echo whose intensity is equal to or larger than a predetermined value, or an area where the intensity of the echo is equal to or larger than the predetermined value.
(10) In the configuration of (9) described above, the determination unit may compare the intensity of the echo in the arrival light with the upper limit value and a lower limit value smaller than the upper limit value, and set an echo having the intensity equal to or larger than the lower limit value and smaller than the upper limit value as the target of the determination. In this way, it is possible to further reduce targets for which determination is performed about whether the echo is from the detection target, and it is possible to further speed up the noise removal processing. Of course, it may be determined that an echo having a predetermined intensity or less is the noise determination target.
(11) In the configurations of (1) to (9) described above, in the determination, the determination unit may handle, as the intensity of the echo, an intensity ratio of an actual intensity difference, which is a difference between a peak intensity of the echo and an external light intensity, to a maximum intensity difference, which is a difference between a maximum intensity obtainable by the echo and the external light intensity. In this way, it is possible to reduce an influence of the external light intensity. Of course, the peak intensity of the echo may be used directly.
(12) According to another configuration of the present disclosure, it is possible to provide a noise removal apparatus for removing noise generated when a detection target is recognized using reflection of light. The noise removal apparatus includes: a measurement unit configured to measure an intensity of arrival light that arrives from a direction corresponding to an emission direction of light emitted toward a predetermined range along an elapsed time from emission of the light; a determination unit configured to determine, when there is an echo having an intensity equal to or larger than a predetermined intensity in the measured arrival light, whether the echo is reflected by the detection target located in the predetermined range, using the intensity of the echo and a detection distance that is a distance corresponding to the elapsed time; a removal unit configured to remove, as noise, the echo determined not to be reflected by the detection target; and a condition setting unit configured to set, based on at least one of an environment where the noise removal apparatus is placed and a characteristic of the measurement unit, a determination condition under which it is determined that there is an echo having the intensity equal to or larger than the predetermined intensity in the measured arrival light. In this way, it is possible to determine whether there is any echo having an intensity equal to or higher than the predetermined intensity in the measured arrival light while reducing an influence of the environment where the noise removal apparatus is placed and the characteristic of the measurement unit.

The environment where such a noise removal apparatus is placed refers to illuminance, weather, a time, and the like of the target measured by the measurement unit of the noise removal apparatus, which affect echo detection. Of course, the environment is not limited thereto, and humidity, wind speed, snowfall, fog, gas, a submersion situation of a road surface, and the like may be considered. As the characteristic of the measurement unit, a difference in sensitivity for each measurement point of the measurement unit, an intensity distribution of noise as electrical noise, or the like may be considered. Since such characteristics of the measurement unit not only differ at the time of factory delivery but also change over time, setting may be performed by acquiring a characteristic value periodically or each time of use.
(13) In the configuration of (12) described above, the condition setting unit may set at least one of a first threshold to be compared with the intensity of the echo and a second threshold to be compared with the detection distance in at least two cases among a first case where the environment is determined to be rainy, a second case where the environment is determined to be sunny, a third case where the environment is determined to be cloudy, and a fourth case where the environment is determined to be nighttime, and perform, in an i-th case and a j-th case (i<j, i, j=1 to 4), at least one of a first setting of setting the first threshold in the i-th case to a value larger than that in the j-th case and a second setting of setting the second threshold in the i-th case to a distance shorter than that in the j-th case. In this way, an influence of weather or the like can be reduced. Classification is not limited to the first to fourth cases, and there may be fewer cases or more cases.
(14) In the configuration of (12) or (13) described above, the condition setting unit may correct the determination condition according to a magnitude of noise detected or learned in advance at a measurement position of the measurement unit such that an influence of the noise is reduced. In this way, the influence of the noise at the measurement position of the measurement unit can be reduced. Such so-called calibration processing may be performed at the time of factory delivery of the noise removal apparatus or at the time of vehicle inspection or the like. The calibration processing may be performed periodically or at any timing.
(15) The configurations of (12) to (14) described above may further include a detection range switching unit configured to switch a range, in which the intensity of the arrival light is read from a measurement range measurable by the measurement unit, between a first range and a second range narrower than the first range, in which the condition setting unit selects the first range or the second range as the determination condition. In this way, it is possible to change ease of noise detection by changing a dynamic range of detection based on a width of the detection range. Therefore, the detection range may be switched to easily determine whether an echo that is possibly noise is noise.
(16) In the configuration of (15) described above, the switching of the detection range may be performed at specific timing, for example, timing when an echo is detected for which it is desired to determine whether the echo is noise, or may be dynamically performed. In the latter case, the processing is dynamically performed, and it is not necessary to perform processing each time to determine whether it is time to switch the detection range.
(17) The present disclosure may be implemented as an object detection apparatus including any one of the above-described noise removal apparatuses and an object detection unit configured to detect an object based on the echo in the signal from which the noise is removed by the noise removal apparatus. In this way, detection accuracy of the object can be improved by detecting the object after accurately removing the noise. The object may be detected by removing the noise from the echo in the arrival light that arrives at the noise detection apparatus from a direction of light emitted to the predetermined range, thus detecting a point located at the detection distance and collecting such points. Further, target object recognition may be performed to recognize that the object is any one of a vehicle, a two-wheeled vehicle, a pedestrian, a drone, a sign, a guard rail, a lane line on a road surface, a plant, and a fence based on an outer shape or movement of the object.
(18) The present disclosure can be implemented as a method of removing noise generated when a detection target is recognized using reflection of light. The noise removal method includes: measuring an intensity of arrival light, which arrives from a direction corresponding to an emission direction of light emitted toward a predetermined range, along an elapsed time from emission of the light; determining, when there is an echo having an intensity equal to or larger than a predetermined intensity in the measured arrival light, whether the echo is reflected by the detection target located in the predetermined range, using the intensity of the echo and a detection distance that is a distance corresponding to the elapsed time; and removing, as noise, the echo determined not to be reflected by the detection target. In this way, since the determination is performed using the intensity of the echo and the detection distance that is the distance corresponding to the elapsed time, it is possible to improve accuracy of noise removal without simply determining that an echo having a weak intensity is noise. Here, as the processing, it is also possible to apply the method described with respect to the noise removal apparatus described above to the noise removal method, for example, determination may be performed using the elapsed time equivalent to the detection distance instead of using the detection distance. For example, when it is determined whether the echo is due to the arrival light from the detection target located in the predetermined range, using the intensity of the echo and the detection distance that is the distance corresponding to the elapsed time, it may be determined whether the echo is noise by performing a determination combining the intensity of the echo and the detection distance, or it may be determined whether the echo is noise by mapping the intensity of the echo and the detection distance in advance and referring to a map based on the intensity of the echo and the detection distance. The same applies to other parts.
(19) In each of the above-described embodiments, a part of a configuration implemented by hardware may be replaced with software. At least a part of a configuration implemented by software may be implemented by a discrete circuit configuration. When a part or all of functions of the present disclosure are implemented by software, the software (computer program) can be provided in a form stored in a computer-readable recording medium. The term “computer-readable recording medium” is not limited to a portable recording medium such as a flexible disk or a CD-ROM, and also includes an internal storage apparatus in a computer such as various RAMs or ROMs and an external storage apparatus fixed to a computer such as a hard disk. That is, the term “computer-readable recording medium” has a wide meaning including any recording medium that can fix a data packet rather than temporarily.

The control unit and the method described in the present disclosure may be implemented by a dedicated computer provided by forming a processor and a memory programmed to execute one or multiple functions embodied by a computer program. Alternatively, the control unit and the method described in the present disclosure may be implemented by a dedicated computer provided by forming a processor with one or more dedicated hardware logic circuits. Alternatively, the control unit and the method described in the present disclosure may be implemented by one or more dedicated computers including a combination of a processor and a memory programmed to execute one or multiple functions and a processor including one or more hardware logic circuits. The computer program may be stored in a computer-readable non-transitory tangible recording medium as an instruction to be executed by a computer.

The present disclosure is not limited to the above-described embodiments, and can be implemented by various configurations without departing from the gist of the present disclosure. For example, the technical features in the embodiments corresponding to the technical features in the aspects described in the summary of the invention can be replaced or combined as appropriate in order to solve a part or all of the above-described problems or in order to obtain a part or all of the above-described effects. In addition, unless the technical features are described as being essential in the present specification, the technical features may be appropriately deleted.

What is claimed is:

1. A noise removal apparatus configured to remove noise generated when a detection target is recognized using reflection of light, the noise removal apparatus comprising:
a measurement unit configured to measure an intensity of arrival light, which arrives in a direction corresponding to an emission direction of light emitted toward a predetermined range, in an elapsed time from emission of the light;
a determination unit configured to determine, when an echo having an intensity equal to or larger than a predetermined intensity arises in the measured arrival light, whether the echo is reflected by the detection target located in the predetermined range, using the intensity of the echo and a detection distance corresponding to the elapsed time; and
a removal unit configured to remove, as noise, the echo determined not to be reflected by the detection target, wherein
when the measurement unit detects, as the echo in the arrival light, a first echo and a second echo having the elapsed time longer than the elapsed time of the first echo, the determination unit is configured to compare an intensity of the first echo with an intensity threshold of a predetermined first value,
when the measurement unit does not detect, as the echo in the arrival light, the second echo having the elapsed time longer than the elapsed time of the first echo, the determination unit is configured to compare the intensity of the first echo with an intensity threshold of a second value smaller than the first value, and
when the intensity of the first echo is smaller than the intensity threshold, the determination unit is configured to determine that the first echo is not reflected by the detection target located in the predetermined range.

2. The noise removal apparatus according to claim 1, wherein
when the arrival light measured by the measurement unit includes, as the echo, the first echo and the second echo having the elapsed time longer than the elapsed time of the first echo, and when the first echo is within a predetermined first distance range, the determination unit is configured to determine that the first echo is not reflected by the detection target located in the predetermined range.

3. The noise removal apparatus according to claim 1, wherein
the measurement unit is configured to detect, as the echo,
an echo in the arrival light from a target point that is one point in the predetermined range, and
echoes in the arrival light from at least two proximity points proximate to the target point, and
when a number of proximity points is equal to or smaller than a predetermined number-of-points threshold, the determination unit is configured to determine that the echo in the arrival light from the target point is not reflected by the detection target located in the predetermined range, wherein
the number of proximity points is the number of the proximity points whose distance difference corresponding to a difference between the elapsed time of the echo in the arrival light from the target point and the elapsed time of the echo in the arrival light of each of the proximity points is equal to or smaller than a predetermined distance threshold.

4. The noise removal apparatus according to claim 3, wherein
the target point and the proximity points are aligned in a predetermined direction, which includes at least one of a vertical direction component and a horizontal direction component.

5. The noise removal apparatus according to claim 3, wherein
the target point and the proximity points are aligned in an order along a predetermined direction,
a first condition is satisfied, when the detection distance corresponding to the elapsed time of the echo from the target point and the detection distance corresponding to the elapsed time of the echo from each of the proximity points monotonically increases or monotonically decreases in the order,
when the first condition is satisfied, the determination unit is configured to set the distance threshold, which is to be compared with the distance difference to obtain the number of proximity points, to a first distance threshold, and
when the first condition is not satisfied, the determination unit is configured to set the distance threshold, which is to be compared with the distance difference to obtain the number of proximity points, to a second distance threshold smaller than the first distance threshold.

6. The noise removal apparatus according to claim 3, wherein
the number-of-points threshold is increased or decreased in at least two stages according to a length of the detection distance corresponding to the elapsed time.

7. The noise removal apparatus according to claim 3, wherein
the target point and the proximity points are aligned in an order along a predetermined direction,
a first condition is satisfied, when the detection distance corresponding to the elapsed time of the echo from the target point and the detection distance corresponding to the elapsed time of the echo from each of the proximity points monotonically increases or monotonically decreases in the order,
the determination unit is configured to sequentially change the target point, which is one point in the predetermined range, to determine whether the number of proximity points is equal to or smaller than the number-of-points threshold, and
even when the determination unit has already determined, for an other target point in the predetermined range, that the number of proximity points is equal to or smaller than the number-of-points threshold, when the first condition is satisfied, the determination unit is configured to determine that the echo in the arrival light from the other target point is reflected by the detection target located in the predetermined range.

8. The noise removal apparatus according to claim 1, wherein
the determination unit is configured to
compare the intensity of the echo in the arrival light with an upper limit value that is a predetermined intensity threshold, and
exclude the echo from a target of the determination when the intensity of the echo is equal to or larger than the upper limit value.

9. The noise removal apparatus according to claim 8, wherein
the determination unit is configured to
compare the intensity of the echo in the arrival light with the upper limit value and a lower limit value smaller than the upper limit value, and
set an echo having the intensity equal to or larger than the lower limit value and smaller than the upper limit value as the target of the determination.

10. The noise removal apparatus according to claim 1, wherein
in the determination, the determination unit is configured to handle, as the intensity of the echo, an intensity ratio of an actual intensity difference, which is a difference between a peak intensity of the echo and an external light intensity, to a maximum intensity difference, which is a difference between a maximum intensity of by the echo and the external light intensity.

11. A noise removal apparatus configured to remove noise generated when a detection target is recognized using reflection of light, the noise removal apparatus comprising:
a measurement unit configured to measure an intensity of arrival light, which arrives from a direction corresponding to an emission direction of light emitted toward a predetermined range, in an elapsed time from emission of the light;
a determination unit configured to determine, when an echo having an intensity equal to or larger than a predetermined intensity arises in the measured arrival light, whether the echo is reflected by the detection target located in the predetermined range, using the intensity of the echo and a detection distance corresponding to the elapsed time;
a removal unit configured to remove, as noise, the echo determined not to be reflected by the detection target; and
a condition setting unit configured to set a determination condition, which is relevant to the intensity of the echo and the detection distance corresponding to the elapsed time, when whether the echo having the intensity equal to or larger than the predetermined intensity arises in the measured arrival light is determined, based on at least one of an environment where the noise removal apparatus is placed and a characteristic of the measurement unit.

12. The noise removal apparatus according to claim 11, wherein
the condition setting unit is configured to
set at least one of a first threshold, which is to be compared with the intensity of the echo, and a second threshold, which is to be compared with the detection distance, in at least two cases among a first case where the environment is determined to be rainy, a second case where the environment is determined to be sunny, a third case where the environment is determined to be cloudy, and a fourth case where the environment is determined to be nighttime, and
perform, in an i-th case and a j-th case (i<j, i, j=1 to 4), at least one of
a first setting to set the first threshold in the i-th case to a value larger than the first threshold in the j-th case and
a second setting to set the second threshold in the i-th case to a distance shorter than the second threshold in the j-th case.

13. The noise removal apparatus according to claim 12, wherein
the condition setting unit is configured to correct the determination condition according to a magnitude of noise detected or learned in advance at a measurement position of the measurement unit, such that an influence of the noise is reduced.

14. The noise removal apparatus according to claim 11, wherein
the condition setting unit is configured to correct the determination condition according to a magnitude of noise detected or learned in advance at a measurement position of the measurement unit, such that an influence of the noise is reduced.

15. The noise removal apparatus according to claim 11, further comprising:
a detection range switching unit configured to switch a range, in which the intensity of the arrival light is read from a measurement range measurable by the measurement unit, between a first range and a second range narrower than the first range, wherein
the condition setting unit is configured to select the first range or the second range as the determination condition.

16. An object detection apparatus comprising:
the noise removal apparatus according to claim 1; and
an object detection unit configured to detect an object based on the echo in a signal from which the noise is removed by the noise removal apparatus.

17. An object detection apparatus comprising:
the noise removal apparatus according to claim 11; and
an object detection unit configured to detect an object based on the echo in a signal from which the noise is removed by the noise removal apparatus.

18. A noise removal method for removing noise generated when a detection target is recognized using reflection of light, the noise removal method comprising:
measuring an intensity of arrival light, which arrives in a direction corresponding to an emission direction of light emitted toward a predetermined range, in an elapsed time from emission of the light;
determining, when an echo having an intensity equal to or larger than a predetermined intensity arises in the measured arrival light, whether the echo is reflected by the detection target located in the predetermined range, using the intensity of the echo and a detection distance corresponding to the elapsed time, the determining including
when a first echo and a second echo having the elapsed time longer than the elapsed time of the first echo is detected as the echo in the arrival light, comparing an intensity of the first echo with an intensity threshold of a predetermined first value,
when the second echo having the elapsed time longer than the elapsed time of the first echo is not detected as the echo in the arrival light, comparing the intensity of the first echo with an intensity threshold of a second value smaller than the first value, and
when the intensity of the first echo is smaller than the intensity threshold, determining that the first echo is not reflected by the detection target located in the predetermined range; and
removing, as noise, the echo determined not to be reflected by the detection target.

19. A noise removal method for removing noise generated when a detection target is recognized using reflection of light, the noise removal method comprising:
measuring an intensity of arrival light, which arrives in a direction corresponding to an emission direction of light emitted toward a predetermined range, in an elapsed time from emission of the light;
setting a determination condition, which is relevant to the intensity of an echo and a detection distance corresponding to the elapsed time, when determining whether an echo having an intensity equal to or larger than a predetermined intensity arises in the measured arrival light, based on at least one of an environment where the recognition is performed and a characteristic when performing the measurement;
determining, when determination that the echo having the intensity equal to or larger than the predetermined intensity arises in the measured arrival light is made under the set determination condition, whether the echo is reflected by the detection target located in the predetermined range, using the intensity of the echo and the detection distance corresponding to the elapsed time; and
removing, as noise, the echo determined not to be reflected by the detection target.
